(19) United States
(12) Patent Application Publication
(10) Pub. No.: US 2018/0084548 A1
(43) Pub. Date: Mar. 22, 2018

(54) ACCESS POINT (AP), STATION (STA) AND METHOD FOR FULL-DUPLEX (FD) COMMUNICATION IN HIGH-EFFICIENCY (HE) ARRANGEMENTS

(71) Applicant: Intel Corporation, Santa Clara, CA (US)

(72) Inventors: Alexander W Min, Portland, OR (US); Minyoung Park, Portland, OR (US)

(21) Appl. No.: 15/272,681

(22) Filed: Sep. 22, 2016

(51) Int. Cl. H04W 72/04; H04L 5/00

(52) U.S. Cl. CPC H04W 72/0453; H04L 5/14; H04L 5/0073

(57) ABSTRACT

Embodiments of an access point (AP), station (STA) and method for full-duplex (FD) communication are generally described herein. The AP may contend for access to channel resources for communication during a transmission opportunity (TXOP). The AP may select, from a master group of STAs, a downlink group of the STAs and an uplink group of the STAs for an FD communication based on inter-STA interference indicators of interference caused between the STAs of the master group by uplink transmissions. The AP may transmit a trigger frame (TF) that indicates the downlink group and an allocation of resource units (RUs) of the channel resources to the STAs of the uplink group for orthogonal frequency division multiple access (OFDMA) transmission of the uplink data. As part of the FD communication, the AP may use overlapping time and channel resources to transmit downlink data to the downlink group and to receive uplink data from the uplink group.

### TECHNICAL FIELD

Embodiments pertain to wireless networks. Some embodiments relate to wireless local area networks (WLANs) and Wi-Fi networks including networks operating in accordance with the IEEE 802.11 family of standards, such as the IEEE 802.11ac standard or the IEEE 802.11ax study group (SG) (named DensiFi). Some embodiments relate to high-efficiency (HE) wireless or high-efficiency WLAN or Wi-Fi communications. Some embodiments relate to full-duplex (FD) communication and/or half-duplex (HD) communication. Some embodiments relate to operation in the presence of overlapping basic service set (OBSS) signals.

### BACKGROUND

Wireless communications have been evolving toward ever increasing data rates (e.g., from IEEE 802.11a/g to IEEE 802.11n to IEEE 802.11ac). In high-density deployment situations, overall system efficiency may become more important than higher data rates. For example, in high-density hotspot and cellular offloading scenarios, many devices competing for the wireless medium may have low to moderate data rate requirements (with respect to the very high data rates of IEEE 802.11ac). A recently-formed study group for Wi-Fi evolution referred to as the IEEE 802.11 High Efficiency WLAN (HEW) study group (SG) (i.e., IEEE 802.11ax) is addressing these high-density deployment scenarios.

### BRIEF DESCRIPTION OF THE DRAWINGS

FIG. 1 illustrates a wireless network in accordance with some embodiments;

FIG. 2 illustrates an example machine in accordance with some embodiments;

FIG. 3 illustrates a station (STA) in accordance with some embodiments and an access point (AP) in accordance with some embodiments;

FIG. 4 illustrates an example scenario in which full-duplex (FD) and/or half-duplex (HD) communication may be used in accordance with some embodiments;

FIG. 5 illustrates the operation of a method of communication in accordance with some embodiments;

FIGS. 6A and 6B illustrate another example scenario in which FD and/or HD communication may be used in accordance with some embodiments;

FIG. 7 illustrates the operation of another method of communication in accordance with some embodiments;

FIG. 8 illustrates another example scenario in which FD and/or HD communication may be used in accordance with some embodiments;

FIG. 9 illustrates the operation of another method of communication in accordance with some embodiments;

FIG. 10 illustrates an example aggregated medium access control protocol data unit (A-MPDU) sub-frame in accordance with some embodiments;

FIG. 11 illustrates additional example scenarios in which FD and/or HD communication may be used in accordance with some embodiments;

FIG. 12 illustrates additional example scenarios in which FD and/or HD communication may be used in accordance with some embodiments;

FIG. 13 illustrates additional example scenarios in which FD and/or HD communication may be used in accordance with some embodiments;

FIGS. 14A and 14B illustrate additional example scenarios in which FD and/or HD communication may be used in accordance with some embodiments; and

FIG. 15 illustrates the operation of another method of communication in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

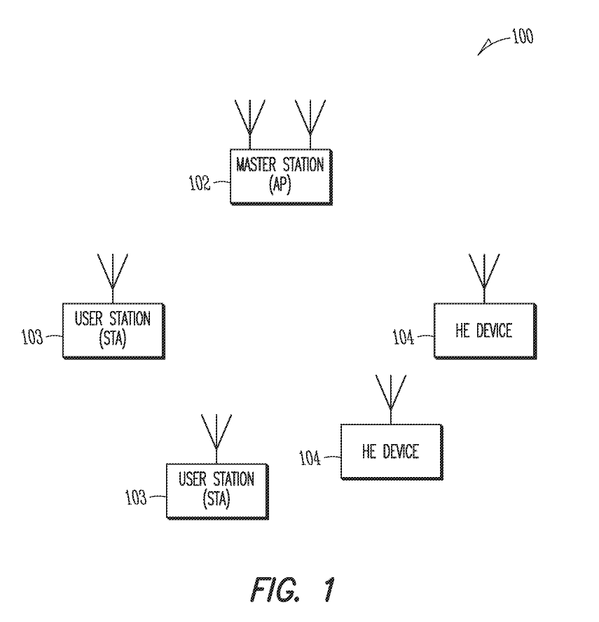

FIG. 1 illustrates a wireless network in accordance with some embodiments. In some embodiments, the network 100 may be a High Efficiency (HE) Wireless Local Area Network (WLAN) network. In some embodiments, the network 100 may be a WLAN or a Wi-Fi network. These embodiments are not limiting, however, as some embodiments of the network 100 may include a combination of such networks. That is, the network 100 may support HE devices in some cases, non HE devices in some cases, and a combination of HE devices and non HE devices in some cases. Accordingly, it is understood that although techniques described herein may refer to either a non HE device or to an HE device, such techniques may be applicable to both non HE devices and HE devices in some cases.

Referring to FIG. 1, the network 100 may include any or all of the components shown, and embodiments are not limited to the number of each component shown in FIG. 1. In some embodiments, the network 100 may include a master station (AP) 102 and may include any number (including zero) of stations (STAs) 103 and/or HE devices 104. In some embodiments, the AP 102 may transmit a trigger frame (TF) to one or more STAs 103 to indicate information about uplink transmissions by the STAs 103. The AP 102 may transmit downlink data to one or more STAs 103 and may receive uplink data from one or more STAs 103. These embodiments will be described in more detail below.

The AP 102 may be arranged to communicate with one or more of the components shown in FIG. 1 in accordance with one or more IEEE 802.11 standards (including 802.11ax and/or others), other standards and/or other communication protocols. It should be noted that embodiments are not limited to usage of an AP 102. References herein to the AP 102 are not limiting and references herein to the master station 102 are also not limiting. In some embodiments, a STA 103, HE device 104 and/or other device may be configurable to operate as a master station. Accordingly, in such embodiments, operations that may be performed by the AP 102 as described herein may be performed by the STA 103, HE device 104 and/or other device that is configurable to operate as the master station.

In some embodiments, one or more of the STAs 103 may be legacy stations. These embodiments are not limiting, however, as the STAs 103 may be configured to operate as HE devices 104 or may support HE operation in some embodiments. The master station 102 may be arranged to communicate with the STAs 103 and/or the HE stations 104 in accordance with one or more of the IEEE 802.11 standards, including 802.11ax and/or others. In accordance with some HE embodiments, an access point (AP) may operate as the master station 102 and may be arranged to contend for a wireless medium (e.g., during a contention period) to receive exclusive control of the medium for an HE control period (i.e., a transmission opportunity (TXOP)). The master station 102 may, for example, transmit a master-sync or control transmission at the beginning of the HE control period to indicate, among other things, which HE stations 104 are scheduled for communication during the HE control period. During the HE control period, the scheduled HE stations 104 may communicate with the master station 102 in accordance with a non-contention based multiple access technique. This is unlike conventional Wi-Fi communications in which devices communicate in accordance with a contention-based communication technique, rather than a non-contention based multiple access technique. During the HE control period, the master station 102 may communicate with HE stations 104 using one or more HE PPDUs. During the HE control period, STAs 103 not operating as HE devices may refrain from communicating in some cases. In some embodiments, the master-sync transmission may be referred to as a control and schedule transmission.

In some embodiments, the multiple-access technique used during the HE control period may be a scheduled orthogonal frequency-division multiple access (OFDMA) technique, although this is not a requirement. In some embodiments, the multiple access technique may be a time-division multiple access (TDMA) technique or a frequency-division multiple access (FDMA) technique. In some embodiments, the multiple access technique may be a space-division multiple access (SDMA) technique including a multi-user (MU) multiple-input multiple-output (MIMO) (MU-MIMO) technique. These multiple-access techniques used during the HE control period may be configured for uplink or downlink data communications.

The master station 102 may also communicate with STAs 103 and/or other legacy stations in accordance with legacy IEEE 802.11 communication techniques. In some embodiments, the master station 102 may also be configurable to communicate with the HE stations 104 outside the HE control period in accordance with legacy IEEE 802.11 communication techniques, although this is not a requirement.

In some embodiments, the HE communications during the control period may be configurable to use one of 20 MHz, 40 MHz, or 80 MHz contiguous bandwidths or an 80+80 MHz (160 MHz) non-contiguous bandwidth. In some embodiments, a 320 MHz channel width may be used. In some embodiments, sub-channel bandwidths less than 20 MHz may also be used. In these embodiments, each channel or sub-channel of an HE communication may be configured for transmitting a number of spatial streams.

In some embodiments, high-efficiency (HE) wireless techniques may be used, although the scope of embodiments is not limited in this respect. As an example, techniques included in 802.11ax standards and/or other standards may be used. In accordance with some embodiments, a master station 102 and/or HE stations 104 may generate an HE packet in accordance with a short preamble format or a long preamble format. The HE packet may comprise a legacy signal field (L-SIG) followed by one or more HE signal fields (HE-SIG) and an HE long-training field (HE-LTF). For the short preamble format, the fields may be configured for shorter-delay spread channels. For the long preamble format, the fields may be configured for longer-delay spread channels. These embodiments are described in more detail below. It should be noted that the terms “HEW” and “HE” may be used interchangeably and both terms may refer to high-efficiency Wireless Local Area Network operation and/or high-efficiency Wi-Fi operation.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware. Embodiments described herein may be implemented into a system using any suitably configured hardware and/or software.

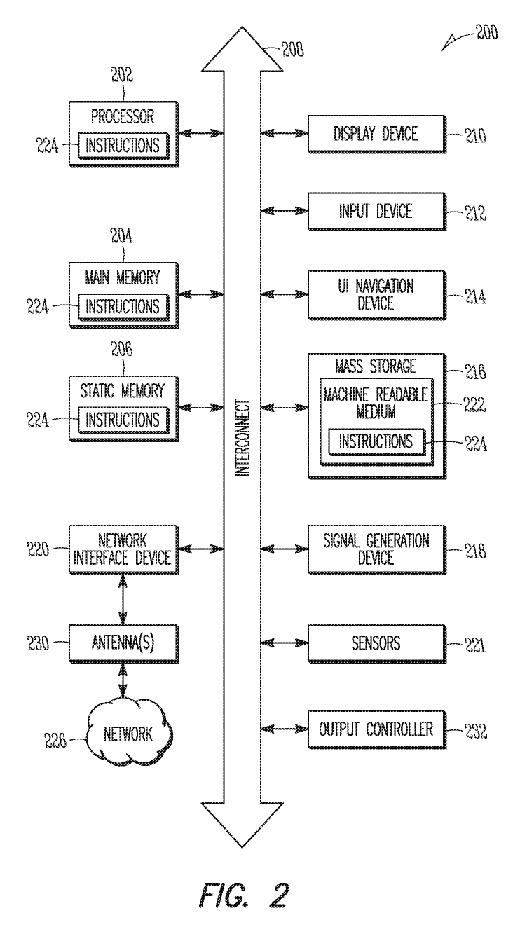

FIG. 2 illustrates a block diagram of an example machine in accordance with some embodiments. The machine 200 is an example machine upon which any one or more of the techniques and/or methodologies discussed herein may be performed. In alternative embodiments, the machine 200 may operate as a standalone device or may be connected (e.g., networked) to other machines. In a networked deployment, the machine 200 may operate in the capacity of a server machine, a client machine, or both in server-client network environments. In an example, the machine 200 may act as a peer machine in peer-to-peer (P2P) (or other distributed) network environment. The machine 200 may be an AP 102, STA 103, HE device, HE AP, HE STA, UE, eNB, mobile device, base station, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The machine (e.g., computer system) 200 may include a hardware processor 202 (e.g., a central processing unit (CPU), a graphics processing unit (GPU), a hardware processor core, or any combination thereof), a main memory 204 and a static memory 206, some or all of which may communicate with each other via an interlink (e.g., bus) 208. The machine 200 may further include a display unit 210, an alphanumeric input device 212 (e.g., a keyboard), and a user interface (UI) navigation device 214 (e.g., a mouse). In an example, the display unit 210, input device 212 and UI navigation device 214 may be a touch screen display. The machine 200 may additionally include a storage device (e.g., drive unit) 216, a signal generation device 218 (e.g., a speaker), a network interface device 220, and one or more sensors 221, such as a global positioning system (GPS) sensor, compass, accelerometer, or other sensor. The machine 200 may include an output controller 228, such as a serial (e.g., universal serial bus (USB)), parallel, or other wired or wireless (e.g., infrared (IR), near field communication (NFC), etc.) connection to communicate or control one or more peripheral devices (e.g., a printer, card reader, etc.).

The storage device 216 may include a machine readable medium 222 on which is stored one or more sets of data structures or instructions 224 (e.g., software) embodying or utilized by any one or more of the techniques or functions described herein. The instructions 224 may also reside, completely or at least partially, within the main memory 204, within static memory 206, or within the hardware processor 202 during execution thereof by the machine 200. In an example, one or any combination of the hardware processor 202, the main memory 204, the static memory 206, or the storage device 216 may constitute machine readable media. In some embodiments, the machine readable medium may be or may include a non-transitory computer-readable storage medium. In some embodiments, the machine readable medium may be or may include a computer-readable storage medium.

While the machine readable medium 222 is illustrated as a single medium, the term “machine readable medium” may include a single medium or multiple media (e.g., a centralized or distributed database, and/or associated caches and servers) configured to store the one or more instructions 224. The term “machine readable medium” may include any medium that is capable of storing, encoding, or carrying instructions for execution by the machine 200 and that cause the machine 200 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks: Random Access Memory (RAM); and CD-ROM and DVD-ROM disks. In some examples, machine readable media may include non-transitory machine readable media. In some examples, machine readable media may include machine readable media that is not a transitory propagating signal.

The instructions 224 may further be transmitted or received over a communications network 226 using a transmission medium via the network interface device 220 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone Service (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 220 may include one or more physical jacks (e.g., Ethernet, coaxial, or phone jacks) or one or more antennas to connect to the communications network 226. In an example, the network interface device 220 may include a plurality of antennas to wirelessly communicate using at least one of single-input multiple-output (SIMO), multiple-input multiple-output (MIMO), or multiple-input single-output (MISO) techniques. In some examples, the network interface device 220 may wirelessly communicate using Multiple User MIMO techniques. The term “transmission medium” shall be taken to include any intangible medium that is capable of storing, encoding or carrying instructions for execution by the machine 200, and includes digital or analog communications signals or other intangible medium to facilitate communication of such software.

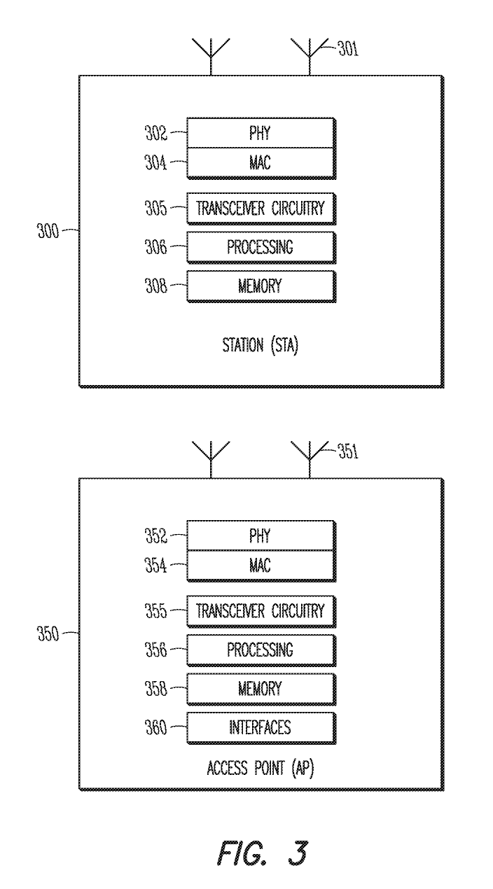

FIG. 3 illustrates a station (STA) in accordance with some embodiments and an access point (AP) in accordance with some embodiments. It should be noted that in some embodiments, an STA or other mobile device may include some or all of the components shown in either FIG. 2 or FIG. 3 (as in 300) or both. The STA 300 may be suitable for use as an STA 103 as depicted in FIG. 1, in some embodiments. It should also be noted that in some embodiments, an AP or other base station may include some or all of the components shown in either FIG. 2 or FIG. 3 (as in 350) or both. The AP 350 may be suitable for use as an AP 102 as depicted in FIG. 1, in some embodiments.

The STA 300 may include physical layer circuitry 302 and a transceiver 305, one or both of which may enable transmission and reception of signals to and from components such as the AP 102 (FIG. 1), other STAs or other devices using one or more antennas 301. As an example, the physical layer circuitry 302 may perform various encoding and decoding functions that may include formation of baseband signals for transmission and decoding of received signals. As another example, the transceiver 305 may perform various transmission and reception functions such as conversion of signals between a baseband range and a Radio Frequency (RF) range. Accordingly, the physical layer circuitry 302 and the transceiver 305 may be separate components or may be part of a combined component. In addition, some of the described functionality related to transmission and reception of signals may be performed by a combination that may include one, any or all of the physical layer circuitry 302, the transceiver 305, and other components or layers. The STA 300 may also include medium access control (MAC) layer circuitry 304 for controlling access to the wireless medium. The STA 300 may also include processing circuitry 306 and memory 308 arranged to perform the operations described herein.

The AP 350 may include physical layer circuitry 352 and a transceiver 355, one or both of which may enable transmission and reception of signals to and from components such as the STA 103 (FIG. 1), other APs or other devices using one or more antennas 351. As an example, the physical layer circuitry 352 may perform various encoding and decoding functions that may include formation of baseband signals for transmission and decoding of received signals. As another example, the transceiver 355 may perform various transmission and reception functions such as conversion of signals between a baseband range and a Radio Frequency (RF) range. Accordingly, the physical layer circuitry 352 and the transceiver 355 may be separate components or may be part of a combined component. In addition, some of the described functionality related to transmission and reception of signals may be performed by a combination that may include one, any or all of the physical layer circuitry 352, the transceiver 355, and other components or layers. The AP 350 may also include medium access control (MAC) layer circuitry 354 for controlling access to the wireless medium. The AP 350 may also include processing circuitry 356 and memory 358 arranged to perform the operations described herein.

The antennas 301, 351, 230 may comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas 301, 351, 230 may be effectively separated to take advantage of spatial diversity and the different channel characteristics that may result.

In some embodiments, the STA 300 may be configured as an HE device 104 (FIG. 1), and may communicate using OFDM and/or OFDMA communication signals over a multicarrier communication channel. In some embodiments, the AP 350 may be configured to communicate using OFDM and/or OFDMA communication signals over a multicarrier communication channel. In some embodiments, the HE device 104 may be configured to communicate using OFDM communication signals over a multicarrier communication channel. Accordingly, in some cases, the STA 300, AP 350 and/or HE device 104 may be configured to receive signals in accordance with specific communication standards, such as the Institute of Electrical and Electronics Engineers (IEEE) standards including IEEE 802.11-2012, 802.11n-2009 and/or 802.11 ac-2013 standards and/or proposed specifications for WLANs including proposed HE standards, although the scope of the embodiments is not limited in this respect as they may also be suitable to transmit and/or receive communications in accordance with other techniques and standards. In some other embodiments, the AP 350, HE device 104 and/or the STA 300 configured as an HE device 104 may be configured to receive signals that were transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect. Embodiments disclosed herein provide two preamble formats for High Efficiency (HE) Wireless LAN standards specification that is under development in the IEEE Task Group 11ax (TGax).

In some embodiments, the STA 300 and/or AP 350 may be a mobile device and may be a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a wearable device such as a medical device (e.g., a heart rate monitor, a blood pressure monitor, etc.), or other device that may receive and/or transmit information wirelessly. In some embodiments, the STA 300 and/or AP 350 may be configured to operate in accordance with 802.11 standards, although the scope of the embodiments is not limited in this respect. Mobile devices or other devices in some embodiments may be configured to operate according to other protocols or standards, including other IEEE standards, Third Generation Partnership Project (3GPP) standards or other standards. In some embodiments, the STA 300 and/or AP 350 may include one or more of a keyboard, a display, a non-volatile memory port, multiple antennas, a graphics processor, an application processor, speakers, and other mobile device elements. The display may be an LCD screen including a touch screen.

Although the STA 300 and the AP 350 are each illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

Embodiments may be implemented in one or a combination of hardware, firmware and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. Some embodiments may include one or more processors and may be configured with instructions stored on a computer-readable storage device.

It should be noted that in some embodiments, an apparatus used by the STA 300 may include various components of the STA 300 as shown in FIG. 3 and/or the example machine 200 as shown in FIG. 2. Accordingly, techniques and operations described herein that refer to the STA 300 (or 103) may be applicable to an apparatus for an STA, in some embodiments. It should also be noted that in some embodiments, an apparatus used by the AP 350 may include various components of the AP 350 as shown in FIG. 3 and/or the example machine 200 as shown in FIG. 2. Accordingly, techniques and operations described herein that refer to the AP 350 (or 102) may be applicable to an apparatus for an AP, in some embodiments. In addition, an apparatus for a mobile device and/or base station may include one or more components shown in FIGS. 2-3, in some embodiments. Accordingly, techniques and operations described herein that refer to a mobile device and/or base station may be applicable to an apparatus for a mobile device and/or base station, in some embodiments.

In accordance with some embodiments, the AP 102 may contend for access to channel resources for communication during a transmission opportunity (TXOP). The AP 102 may select, from a master group of STAs 103, a downlink group of the STAs 103 and an uplink group of the STAs 103 for an FD communication based on inter-STA interference indicators of interference caused between the STAs 103 of the master group by uplink transmissions. The AP 102 may transmit a trigger frame (TF) that indicates the downlink group and an allocation of resource units (RUs) of the channel resources to the STAs 103 of the uplink group for orthogonal frequency division multiple access (OFDMA) transmission of the uplink data. As part of the FD communication, the AP 102 may use overlapping time and channel resources to transmit downlink data to the downlink group and to receive uplink data from the uplink group.

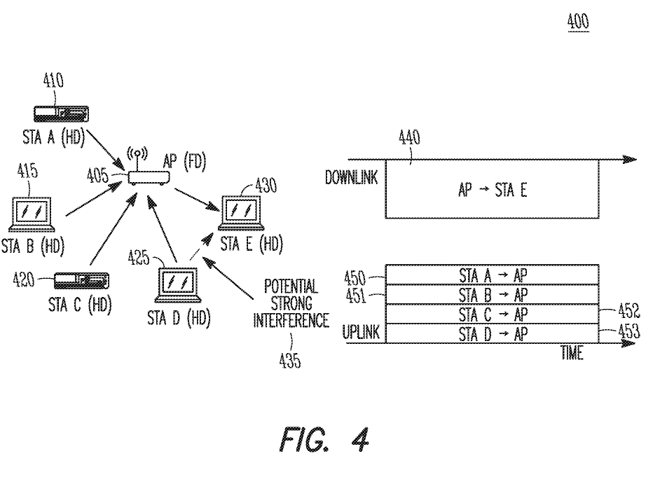

FIG. 4 illustrates an example scenario in which FD and/or HD communication may be used in accordance with some embodiments. It should be noted that the example scenario 400 shown in FIG. 4 may illustrate some or all of the concepts and techniques described herein in some cases, but embodiments are not limited by the example scenario 400. For instance, embodiments are not limited by the name, number, type, size, ordering, arrangement and/or other aspects of the frames, signals, fields, data blocks, time resources, channel resources and other elements as shown in FIG. 4. Although some of the elements shown in the examples of FIG. 4 may be included in an 802.11 standard and/or other standard, embodiments are not limited to usage of such elements that are included in standards.

Referring to FIG. 4, in the example scenario 400, full-duplex (FD) communication with OFDMA-aggregated uplink and downlink transmissions among an FD-capable AP 405 and half-duplex (HD) capable STAs 410-430 is illustrated. It should be noted that as part of FD operation, a device may transmit and receive signals in time resources and channel resources that overlap. In some cases, the time resources and/or channel resources may substantially overlap. In some embodiments, as part of an FD communication, the AP 405 of FIG. 4 may transmit downlink signals to one or more of the STAs 410-430, while one or more of the STAs 410-430 may transmit uplink signal(s) to the AP 405. The downlink and uplink transmissions may be performed in time and channel resources that overlap. In some cases, such overlap may be substantial (such as at least 50%, at least 70%, at least 90% and/or other suitable percentage). Accordingly, as part of the FD communication, the downlink and uplink transmissions may be performed in time periods that substantially overlap and in channel resources that substantially overlap. In accordance with HD operation, the STAs 410-430 may transmit signals or receive signals during a time period, but generally may not transmit and receive signals in the same time resources and channel resources.

In some embodiments, OFDMA-based FD communication using Multi-User (MU) OFDMA uplink and downlink transmissions between half-duplex capable STAs 410-430 and a full-duplex capable AP 405 may be used so that the AP 405 may match the uplink and downlink transmission time and minimize spectrum waste. For example, when there is a large downlink frame (such as frame 440 from the AP 405 to the STA E 430) and multiple smaller uplink frames (such as frames 450-453 from STAs A/B/C/D (410-425) to the AP 405), the AP 405 may aggregate multiple uplink transmissions by allocating smaller resource blocks (or Resource Units (RUs) or sub-channels) to them in an OFDMA packet format, as shown in the example scenario 400 in FIG. 4.

However, such simultaneous uplink and downlink transmissions may interfere with each other, in some cases. As an example, the uplink transmissions from any or all of STAs A/B/C/D (410-425) may cause interference to downlink transmission such as from the AP 405 to STA E (430). As indicated by 435, a signal transmitted from STA D (425) may cause significant interference to STA E (430). For instance, the uplink transmission 453 from STA D (425) to the AP 405 may cause significant interference, in some cases, to the downlink transmission 440 from the AP 405 to the STA E (430). Such interference may cause undesired effects, such as frame loss, lower throughput, reduction of overall spectrum efficiency and/or others.

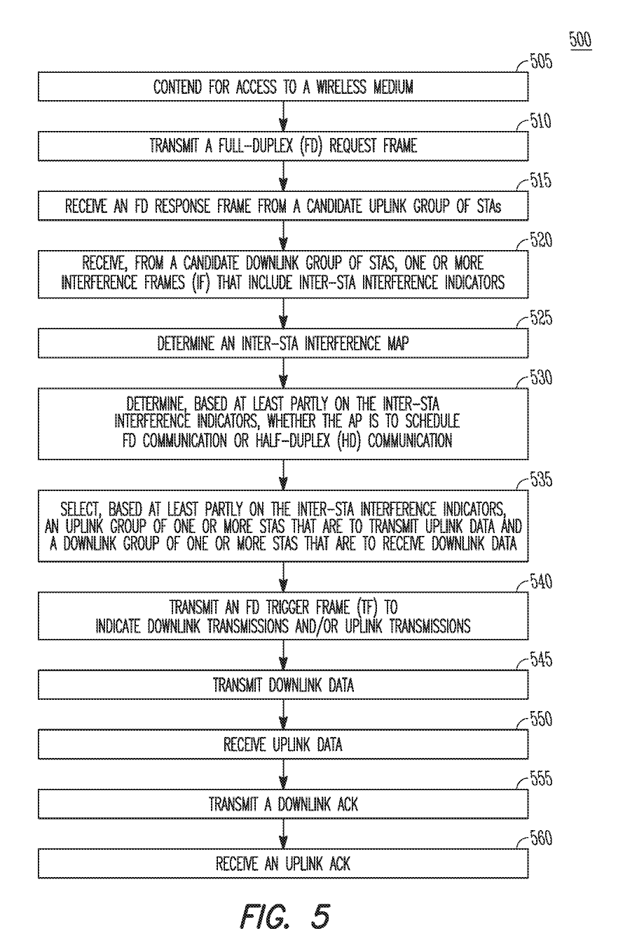

FIG. 5 illustrates the operation of a method of communication in accordance with some embodiments. It is important to note that embodiments of the method 500 may include additional or even fewer operations or processes in comparison to what is illustrated in FIG. 5. In addition, embodiments of the method 400 are not necessarily limited to the chronological order that is shown in FIG. 5. In describing the method 500, reference may be made to FIGS. 1-4 and 6-15, although it is understood that the method 500 may be practiced with any other suitable systems, interfaces and components.

In some embodiments, the STA 103 may be configurable to operate as an HE device 104. Although reference may be made to an STA 103 herein, including as part of the descriptions of the method 500 and/or other methods described herein, it is understood that an HE device 104 and/or STA 103 configurable to operate as an HE device 104 may be used in some embodiments. In addition, the method 500 and other methods described herein may be applicable to STAs 103, HE devices 104 and/or APs 102 operating in accordance with one or more standards and/or protocols, such as 802.11, Wi-Fi, wireless local area network (WLAN) and/or other, but embodiments of those methods are not limited to just those devices. In some embodiments, the method 500 and other methods described herein may be practiced by other mobile devices, such as an Evolved Node-B (eNB) or User Equipment (UE). The method 500 and other methods described herein may also be practiced by wireless devices configured to operate in other suitable types of wireless communication systems, including systems configured to operate according to various Third Generation Partnership Project (3GPP) Long Term Evolution (LTE) standards. The method 400 may also be applicable to an apparatus for an STA 103, HE device 104 and/or AP 102 or other device described above, in some embodiments.

It should also be noted that embodiments are not limited by references herein (such as in descriptions of the methods 500, 700, 900, 1500 and/or other descriptions herein) to transmission, reception and/or exchanging of elements such as frames, messages, requests, indicators, signals or other elements. In some embodiments, such an element may be generated, encoded or otherwise processed by processing circuitry (such as by a baseband processor included in the processing circuitry) for transmission. The transmission may be performed by a transceiver or other component, in some cases. In some embodiments, such an element may be decoded, detected or otherwise processed by the processing circuitry (such as by the baseband processor). The element may be received by a transceiver or other component, in some cases. In some embodiments, the processing circuitry and the transceiver may be included in a same apparatus. The scope of embodiments is not limited in this respect, however, as the transceiver may be separate from the apparatus that comprises the processing circuitry, in some embodiments.

At operation 505 of the method 500, the AP 102 may contend for access to a wireless medium. In some embodiments, the AP 102 may contend for the wireless medium during a contention period to receive exclusive control of the medium during a period, including but not limited to a TXOP and/or HE control period. The AP 102 may transmit a frame and/or message during the TXOP and/or HE control period, in some embodiments. However, it should be noted that embodiments are not limited to transmission during the TXOP and/or HE control period or transmission in accordance with the exclusive control of the medium. Accordingly, an A-MPDU, A-MPDU sub-frame, HE PPDU and/or other frame/sub-frame may be transmitted in contention-based scenarios and/or other scenarios, in some cases.

At operation 510, the AP 102 may transmit an FD request frame. At operation 515, the AP 102 may receive, from one or more STAs 103, an FD response frame. In some embodiments, the AP 102 may communicate with a master group of STAs 103. As a non-limiting example, the master group may include STAs 103 that are associated with the AP 102. As another non-limiting example, the master group may include STAs 103 that have established communication with the AP 102, registered with the AP 102 and/or otherwise become communicatively coupled to the AP 102. Such actions may have occurred during a recent time period, in some cases (such as before a service timeout and/or other event occurs). As another non-limiting example, the master group may include STAs to which the AP 102 has communicated and/or plans to communicate (in either the downlink or uplink direction or both).

At operation 520, the AP 102 may receive, from STAs 103 of a candidate downlink group (and/or other STAs 103), one or more interference frames (IFs). In some embodiments, the STAs 103 of the candidate downlink group may be included in the master group. The STAs 103 may be selected for the candidate downlink group by the AP 102, in some embodiments, based on one or more factors such as a fairness scheduling criterion, amounts of downlink data that are to be sent to the STAs 103 and/or others. For instance, the AP 102 may select STAs 103 to the candidate downlink group based on such factors, and may subsequently perform operations based on inter-STA interference (to be described below) to determine whether those STAs 103 of the candidate downlink group are to be selected to receive downlink data (and/or selected to a downlink group of STAs 103). Similar techniques may be applied to a candidate uplink group and an uplink group, as will be described below.

In some cases, the AP 102 may receive inter-STA interference indicators (to be described below) that may be included in the IF frames. The scope of embodiments is not limited in this respect, however, as the AP 102 may receive inter-STA interference indicators in other frames and/or messages, in some cases. In addition, the usage of terminology such as “candidate downlink group of the STAs 103,” “candidate uplink group of the STAs 103,” “uplink group of the STAs 103” and/or “downlink group of the STAs 103” is not limiting. For instance, STAs 103 included in such groups may be referred to, without limitation, as candidate downlink STAs 103, candidate uplink STAs 103, downlink STAs 103, uplink STAs 103 and/or similar, in some cases.

In some embodiments, the FD request frame may indicate a request to receive, from one or more STAs 103 of a candidate uplink group, information related to potential uplink data transmissions by those STAs 103. In some embodiments, the STAs 103 from which the FD request frame is received may include STAs 103 that have previously reported that they have uplink data to transmit, such as queued uplink data. In some embodiments, the AP 102 may select STAs 103 from the master group to be included in the candidate uplink group based on other factors, such as fairness of scheduling and/or others. Examples of information requested may include or may be related to uplink data resources desired by the STAs 103, quantities of uplink data that the STAs 103 wish to send to the AP 102, desired uplink data rates and/or others. In some cases, it may be intended that the STAs 103 report such information in the FD response frame. As an example, the AP 102 may select STAs 103 to the candidate uplink group based on such factors, and may subsequently perform operations based on inter-STA interference (to be described below) to determine whether those STAs 103 of the candidate uplink group are to be selected to transmit uplink data (and/or selected to an uplink group of STAs 103).

In some embodiments, the FD request frame may indicate an allocation of RUs to be used, by the STAs 103 of the candidate uplink group (and/or other STAs 103), for OFDMA transmission of the FD response frame. In some embodiments, the FD request frame may indicate a request that the STAs 103 send the FD response frame, and the request may or may not be related to a request for information about uplink data, such as described above. It should be noted that the FD request frame may be transmitted to other STAs 103 (such as STAs 103 that may not necessarily be selected for the candidate uplink group), in some cases.

In some embodiments, the FD request frame may indicate a request to receive, from one or more STAs 103 of the candidate downlink group, information related to potential inter-STA interference that may be caused to those STAs 103. In some embodiments, the FD request frame may indicate a request to receive, from one or more of the STAs of the candidate downlink group and/or other STAs 103, interference frames (IFs) that include inter-STA interference indicators. As an example, the inter-STA interference indicators may be based on measurements, at one or more STAs 103 of the master group, of inter-STA interference caused by uplink transmissions of other STAs 103 of the master group. For instance, an STA 103 of the candidate downlink group may take measurements, such as received power, on the FD response frame that is transmitted by one or more STAs 103 of the candidate uplink group and/or other STAs. The STA 103 of the candidate downlink group may determine, from the FD request frame, the allocation of RUs to be used by the STAs 103 of the candidate uplink group for the FD response frame, and may measure the received power of the OFDMA signal (FD response frame) in different RUs. With knowledge of the particular STAs 103 that transmitted in the different RUs, the STA 103 of the candidate downlink group may determine inter-STA interference measurements from those STAs to the STA 103 of the candidate downlink group. These inter-STA interference measurements may be reported to the AP 102 in an IF.

It should be noted that in some embodiments, the AP 102 may indicate one or more STAs 103 that are to transmit IFs using frames other than the FD request frame. For instance, a beacon frame or a management frame may be used.

In some embodiments, the STAs 103 of the candidate downlink group may include STAs 103 for which the AP 102 intends to send downlink data. For instance, fairness of scheduling may be used to select one or more STAs 103 for the candidate downlink group. The AP 102 may select the STAs 103 of the candidate downlink group from the master group of STAs 103, based on factors such as amounts of data to be transmitted to one or more STAs 103 of the master group, elapsed durations since previous downlink transmissions to the STAs 103 of the master group, parameters (like target latency, minimum data rate and/or others) of applications operating at the AP 102 and/or STAs 103 and/or factors.

At operation 525, the AP 102 may determine an inter-STA interference map. The map may be based at least partly on inter-STA interference indicators, such as those received at operation 520. In addition, previously received inter-STA interference measurements, such as measurements included in IFs previously transmitted by STAs 103 of the master group, may be used. Accordingly, the AP 102 may collect information about the master group of STAs 103, such as how much they may interfere with each other during uplink transmission. As an example, the AP 102 may have inter-STA interference information about possible interference caused by each of the STAs 103 in the master group to each of the other STAs 103 in the master group (or at least a portion of such information). In this case, it may be possible that the map is not complete and the AP 102 may request measurements in response. It should be noted that the map may be used for operations such as 530, 535 and/or others, in some cases, but embodiments are not limited to formation of an explicit map for this purpose. The AP 102 may use inter-STA interference indicators that it knows and/or has received, which may not necessarily be in a map format. It should also be noted that other frames and/or messages received at the AP 102 may also include inter-STA interference measurements that may be used by the AP 102, in some embodiments.

At operation 530, the AP 102 may determine whether to schedule FD communication or half-duplex (HD) communication. At operation 535, the AP 102 may select, for an FD communication, an uplink group of one or more STAs 103 (from the master group and/or candidate uplink group) that are to transmit uplink data and a downlink group of one or more STAs 103 (from the master group and/or candidate downlink group) that are to receive downlink data. The AP 102 may select, for an HD communication, a downlink group of one or more STAs 103 (from the master group and/or candidate downlink group) that are to receive downlink data. The determination of whether to use FD or HD communication and/or the selection of STAs 103 for the downlink communication and/or uplink communication may be based at least partly on the inter-STA interference measurements, in some embodiments. In addition, any number of other factors may also be used, in some cases, such as an expected time for a downlink transmission or an uplink transmission, a scheduling fairness criterion for the STAs 103 of the master group, inter-node interference at the AP 102 or the STAs 103 of the master group, a target latency of an application of the AP 102 or STA 103 and/or other factors.

Non-limiting examples of the determination of whether to use FD or HD communication, the determination of which STAs 103 are to receive downlink signals from the AP 102 and/or which STAs 103 are to transmit uplink signals to the AP 102 are described below. Embodiments are not limited by these examples. In some embodiments, one or more techniques described in these examples may be used. In some embodiments, one or more other techniques may be used, in addition to or instead of those described in the examples below.

In some embodiments, STAs 103 of the downlink and uplink groups may be selected based at least partly on expected inter-STA interference that would be caused to the STAs 103 of the downlink group by the STAs 103 of the uplink group. In some embodiments, the STAs 103 selected to the downlink group may be selected from a candidate downlink group and/or master group. In addition, the STAs 103 selected to the uplink group may be selected from a candidate uplink group and/or master group, in some embodiments.

The expected inter-STA interference may be based at least partly on one or more of the inter-STA interference indicators received at the AP 102. For instance, when a first STA 103 is expected to cause a level of interference to a second STA 103 that is above a predetermined threshold, the AP 102 may refrain from scheduling an FD communication in which the first STA 103 is to transmit uplink data and the second STA 103 is to receive downlink data. In a first example option in this case, the AP 102 may exclude the first STA 103 from an uplink group of STAs 103 for the FD communication and may include the second STA 103 in a downlink group of STAs 103 for the FD communication. In a second example option in this case, the AP 102 may include the first STA 103 in the uplink group for the FD communication and may exclude the second STA 103 from the downlink group for the FD communication. A decision on whether to use the first or second option and/or other option may be based on other factors, such as how much uplink data is queued at the first STA 103, how much downlink data for the second STA 103 is queued at the AP 102 and/or other factors. Embodiments are not limited to the two example options described, as other options and/or additional options may be used in some cases.

In some embodiments, inter-STA interference indicators for STAs 103 that are not necessarily indicated in the FD request frame may be used. For instance, if one or more STAs 103 of the candidate uplink group is excluded based on expected interference to an STA 103 of the candidate downlink group, the AP 102 may select another STA 103 for uplink transmission. Accordingly, the AP 102 may have previously stored inter-STA interference measurements that indicate measured inter-STA interference caused by the other STA 103 to the STA 103 of the candidate downlink group. If those measurements are acceptable to the AP 102, the other STA 103 may be scheduled for the FD communication.

At operation 540, the AP 102 may transmit an FD trigger frame (TF) that indicates, for the FD communication, one or more STAs 103 that are to transmit uplink data (uplink group of the STAs 103) and one or more STAs 103 that are to receive downlink data (downlink group of the STAs 103). It should be noted that embodiments are not limited to the FD-TF, as other TFs and/or other frames may be used in some embodiments. At operation 545, the AP 102 may transmit one or more downlink data frames to one or more STAs 103 of the downlink group as part of the FD communication. At operation 550, the AP 102 may receive one or more uplink data frames from one or more STAs 103 of the uplink group as part of the FD communication. At operation 555 and 560, the AP 102 may exchange downlink acknowledgement (ACK) messages and/or uplink ACK messages with one or more STAs 103. The ACK messages may be related to data frames transmitted and/or received by the AP 102 during any suitable time period. It should be noted that, in some embodiments, operations 545 and 550 may be performed simultaneously and/or during time periods that at least partly overlap, although the scope of embodiments is not limited in this respect. It should be noted that, in some embodiments, operations 555 and 560 may be performed simultaneously and/or during time periods that at least partly overlap, although the scope of embodiments is not limited in this respect.

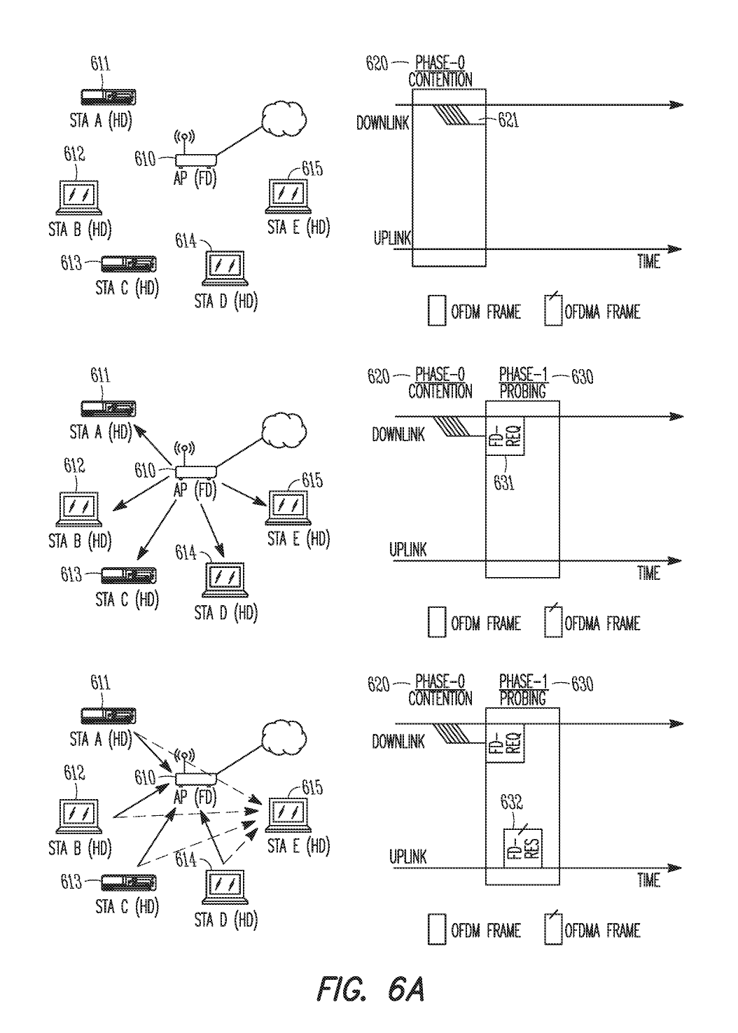

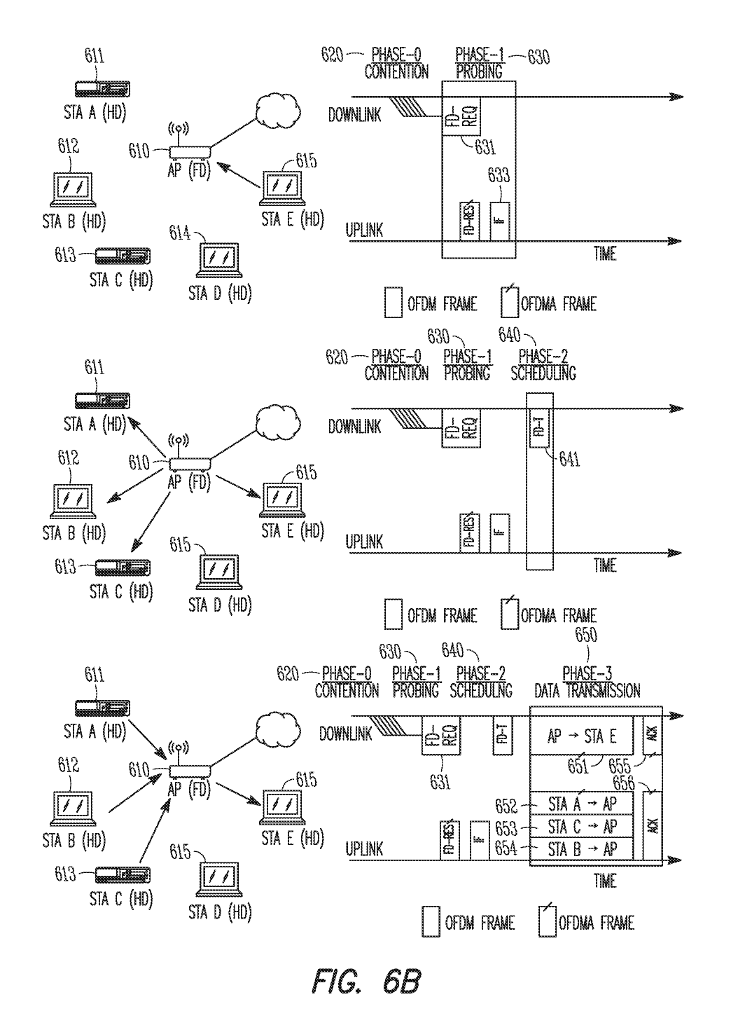

FIGS. 6A and 6B illustrate another example scenario in which FD and/or HD communication may be used in accordance with some embodiments. It should be noted that the example scenario shown in FIGS. 6A and 6B may illustrate some or all of the concepts and techniques described herein (including but not limited to those of methods 500 and 700), but embodiments are not limited by the example scenario. For instance, embodiments are not limited by the name, number, type, size, ordering, arrangement and/or other aspects of the APs 102, STAs 103, frames, signals, fields, data blocks, time resources, channel resources and other elements as shown in FIGS. 6A and 6B. Although some of the elements shown in the examples of FIGS. 6A and 6B may be included in an 802.11 standard and/or other standard, embodiments are not limited to usage of such elements that are included in standards.

It should be noted that operations shown in FIGS. 6A and 6B are illustrated in terms of phases, such as phases 0-3, but this is not limiting. That is, the operations may be performed without the usage of explicit phases, in some embodiments. In addition, embodiments are not limited to the number of phases shown or to the grouping of operations/frames into the phases as shown. In addition, some of the frames are marked with a dashed line at the top to indicate OFDMA transmission while others do not have the dashed line to indicate non-OFDMA transmission. It should be noted that embodiments are not limited to the designations shown for OFDMA transmission and/or non-OFDMA transmission of the frames shown.

In addition, an STA 103 may be referred to, in some cases, as an “uplink STA” and/or “downlink STA,” but such references are not limiting. For instance, a downlink signal may be transmitted by the AP 102 to a first STA 103 and an uplink signal may be received by the AP 102 from a second STA 103. In some cases, the first STA 103 may be referred to as a downlink STA 103 and the second STA 103 may be referred to as an uplink STA 103, but it is understood that the STAs 103 may be configured to perform downlink reception and/or uplink reception. For instance, the first STA 103 may be referred to, for purposes of clarity, as a downlink STA 103 when receiving downlink data and may be referred to as an uplink STA 103 when transmitting uplink data.

Referring to FIGS. 6A and 6B, in phase 0 (620), the AP 610 may have downlink data for one or more STAs 611-615, such as STA E (615) in this example. The AP 610 may contend and may win the channel contention, as indicated by 621.

In phase 1 (630), the AP 610 may identify uplink transmission needs and/or requests from STAs 611-615. The AP 610 may send the FD Request Frame (FD-Req) 631 to a subset of STAs 611-615, requesting them to report uplink transmission needs and/or requests (for instance, amounts of data for uplink transmission). The FD Request Frame 631 may include, among other things, OFDMA sub-channel allocation information for one or more of STAs 611-615 for their Probe Response Frame. Candidate uplink STAs (such as STAs A/B/C/D 611-614) may respond to the AP 610 with FD Response Frames (FD-Res) 632 to inform their uplink transmission needs and/or requests (for instance, amounts of uplink data using the sub-channel allocated by the AP 610). While the STAs 611-614 may send the FD Response Frames 632 to the AP 610, the target downlink STA (such as STA E 615) may listen and may measure the received signal strength on each OFDMA sub-channel (for instance, a 2 MHz sub-channel or other suitable size sub-channel). The target downlink STA E 615 may send the Interference Frame (IF) 633 reporting the measured signal strength information to the AP 610 for each sub-channel. In this example, STA E 615 may report that a strong interference has been measured in the sub-channel allocated to STA D 614. Upon receipt of the Interference Frame 633, the AP 610 may link the reported interference on each sub-channel with the sub-channel allocation in the FD Request Frame 631 and updates the interference relation among one or more of the STAs 611-615. It should be noted that embodiments are not limited to time scaling of transmissions shown in FIGS. 6A and 6B. As an example, the transmission of the FD-Res 632 may begin after the end of the transmission of the FD Req frame 631. In some cases, a delay, such as an IFS or other, may occur between the end of the transmission of the FD Req 631 and the beginning of the transmission of the FD-Res 632. As another example, the transmission of the IF 633 may begin after the end of the transmission of the FD-Res 632. In some cases, a delay, such as an IFS or other, may occur between the end of the transmission of the FD-Res 632 and the beginning of the transmission of the IF 633.

In Phase 2 (640), upon the reception of the uplink transmission requests from the candidate uplink STAs (for instance, amounts of uplink data buffered) and interference measurement information from the target downlink STA E 615, the AP 610 may schedule uplink and downlink OFDMA transmissions in such a way that a total full-duplex link throughput may be maximized (or at least an attempt at maximizing or increasing such a throughput may be made). In this example, since there is a strong interference from STA D 614 to STA E 615, the AP 610 may exclude STA D 614 from the uplink OFDMA transmission.

The AP 610 may consider one or more of the following factors (and/or one or more additional factors in some cases) for scheduling: expected transmission time for uplink and downlink transmissions, fairness in channel access among STAs, inter-node interference among AP and STAs, target latencies from applications and/or others. The AP 610 may send out the uplink scheduling information to selected STAs (such as STAs A/B/C 611-613). For instance, an FD trigger frame (TF) 641 may be used. In phase 3 (650), the AP 610 may send downlink data to one or more STAs (in this example to STA E 615). The STAs A/B/C (611-613) may send uplink data to the AP 610. The STAs 611-613 may begin uplink data transmissions 652-654 using sub-channels allocated by the AP 610 in the Trigger Frame (FD-TF) 641. The AP 610 and one or more STAs (such as any of 611, 612, 613 and 615) may send one or more ACK frames (such as 655 and/or 656) at the end of the data transmissions (651, 652-654).

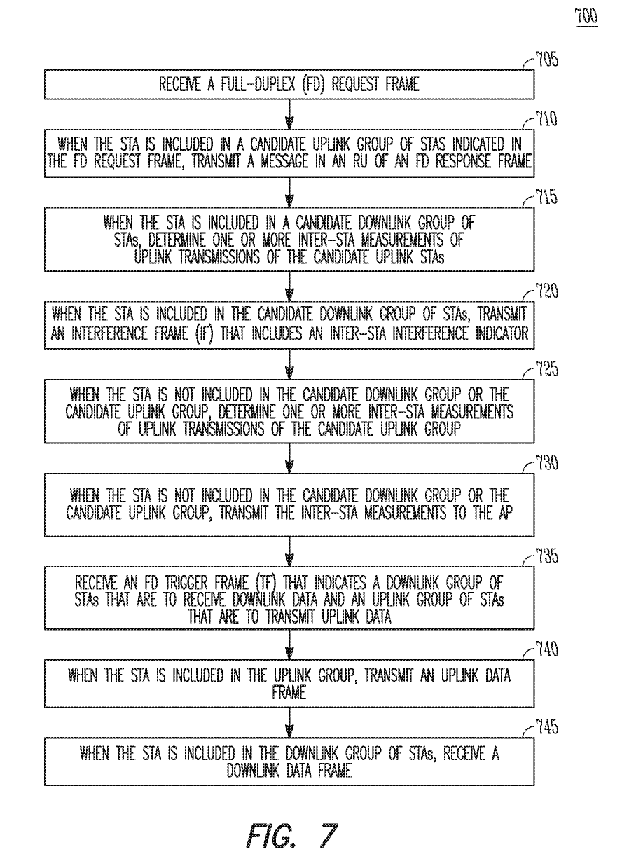

FIG. 7 illustrates the operation of another method of communication in accordance with some embodiments. As mentioned previously regarding the method 500, embodiments of the method 700 may include additional or even fewer operations or processes in comparison to what is illustrated in FIG. 7 and embodiments of the method 700 are not necessarily limited to the chronological order that is shown in FIG. 7. In describing the method 700, reference may be made to FIGS. 1-6 and 8-15, although it is understood that the method 700 may be practiced with any other suitable systems, interfaces and components. In addition, embodiments of the method 700 may be applicable to APs 102, STAs 103, UEs, eNBs or other wireless or mobile devices. The method 700 may also be applicable to an apparatus for an AP 102, STA 103 and/or other device described above.

It should be noted that the method 700 may be practiced by an STA 103 and may include exchanging of elements, such as frames, signals, messages, fields and/or other elements, with an AP 102. Similarly, the method 500 may be practiced at an AP 102 and may include exchanging of such elements with an STA 103. In some cases, operations and techniques described as part of the method 500 may be relevant to the method 700. In addition, embodiments of the method 700 may include operations performed at the STA 103 that are reciprocal to or similar to other operations described herein performed at the AP 102. For instance, an operation of the method 700 may include reception of a frame from the AP 102 by the STA 103 while an operation of the method 500 may include transmission of the same frame or similar frame by the AP 102.

In addition, previous discussion of various techniques and concepts may be applicable to the method 700 in some cases, including full-duplex (FD), half-duplex (HD), FD request frames, FD response frames, interference frames (IFs), FD trigger frames (TFs), inter-STA interference measurements, candidate uplink group of STAs, candidate downlink group of STAs, downlink group of STAs, uplink group of STAs, master group of STAs and/or others. In addition, the examples shown in FIGS. 6A and 6B may also be applicable, in some cases, although the scope of embodiments is not limited in this respect.

At operation 705, the STA 103 may receive an FD request frame from an AP 102 that indicates a candidate downlink group of one or more STAs 103 and a candidate uplink group of one or more STAs 103 for an FD communication. The FD request frame may further indicate an allocation of resource units (RUs) to the STAs 103 of the candidate uplink group for OFDMA transmission of an FD response frame.

At operation 710, when the STA 103 is included in the candidate uplink group, the STA 103 may encode a message for transmission in the FD response frame in the RU allocated to the STA 103 in the FD request frame.

At operation 715, when the STA 103 is included in the candidate downlink group, the STA 103 may determine inter-STA measurements of one or more of the STAs of the candidate uplink group based on received power measurements of the FD response frame at the STA 103 and further based on the RU allocation indicated by the FD request frame. In some embodiments, the STA 103 may determine the inter-STA measurements of each of the STAs 103 of the candidate uplink group based on a measurement, at the STA 103, of a received power of the FD request frame in the RU allocated to each of the STAs 103 of the candidate uplink group.

At operation 720, when the STA 103 is included in the candidate downlink group, the STA 103 may transmit an interference frame (IF) that includes one or more inter-STA interference measurements. Embodiments are not limited to usage of IFs for the transmission of the inter-STA interference measurements. Other frames and/or messages may be used by the STA 103 to transmit the measurements to the AP 102.

At operation 725, when the STA 103 is not included in the candidate uplink group or the candidate downlink group, the STA 103 may determine inter-STA measurements of the STAs 103 of the candidate uplink group. In some embodiments, the measurements may be based on received power measurements of the FD response frame at the STA 103 and further based on the RU allocation indicated by the FD request frame. At operation 730, when the STA 103 is not included in the candidate uplink group or the candidate downlink group, the STA 103 may transmit the inter-STA measurements to the AP 102.

At operation 735, the STA 103 may receive an FD trigger frame (TF) that indicates a downlink group of STAs 103 that are to receive downlink data from the AP 102 during an FD period and an uplink group of STAs 103 that are to transmit uplink data to the AP 102 during the FD period.

At operation 740, when the STA 103 is included in the uplink group, the STA 103 may transmit one or more uplink data frames for uplink OFDMA transmission in an RU indicated in the FD-TF during the FD period. At operation 745, when the STA 103 is included in the downlink group, the STA 103 may receive one or more downlink data frames during the FD period.

In some embodiments, an STA 103 that does not transmit the FD Response Frame may measure interference by measuring the received signal strength of the FD Response Frames on each OFDMA sub-channel. In this case, the STA 103 may have and/or may determine the sub-channel allocation information extracted from the FD Request Frame transmitted by the AP 102 before the FD Response Frames. Such received signal strength (or interference) information may be reported to the AP 102 for purposes such as determination of whether to use FD or HD, selection of downlink and/or uplink groups of the STAs 103, construction of an interference map and/or others.

In some embodiments, the STAs 103 may continuously measure interference from other STAs 103 in an opportunistic manner using on-going frame transmissions (for instance, not only the FD Response Frames, but also half-duplex MU OFDMA UL transmissions). In some cases, this may be performed as long as the STAs 103 have and/or may determine accurate information regarding the mapping between transmitting STAs 103 and a list of sub-channels that they are using for half-duplex frame transmissions.

In some embodiments, when full-duplex data transmission happens, the STAs 103 may refrain from measurement of interference. For instance, an STA 103 that is not transmitting may refrain from measurement of interference of uplink frame transmissions in the presence of simultaneous downlink frame transmission.

In some embodiments, the AP 102 may explicitly schedule Interference Frame transmission for a target downlink STA after the FD Response Frames. For example, the AP 102 may indicate such scheduling of Interference Frame transmission for the target downlink STA 103 in the FD Request Frame. Otherwise, for example, if the AP 102 already has sufficient information regarding the inter-STA interference of a particular target STA 103, it may indicate in the FD Request Frame that the particular target STA 103 is to refrain from transmission of such Interference Frames. In this case, the AP 102 may send an FD-TF after receiving the FD Response Frames.

In some embodiments, the AP 102 may explicitly request a subset of STAs 103 that are to report up-to-date interference measurements using Interference Frames in stand-alone, contention-based packet exchanges. Such requests may be conveyed in a Beacon frame or in a new management frame (for instance, an interference measurement report request frame and/or other). Such requests may indicate the frequency of such reports, for instance if it is to be a one time or periodic update, or any other conditions that may be used by the STA 103 to determine when to update the interference measurement. For instance, a mobility status change from static to mobile may be used, in some cases.

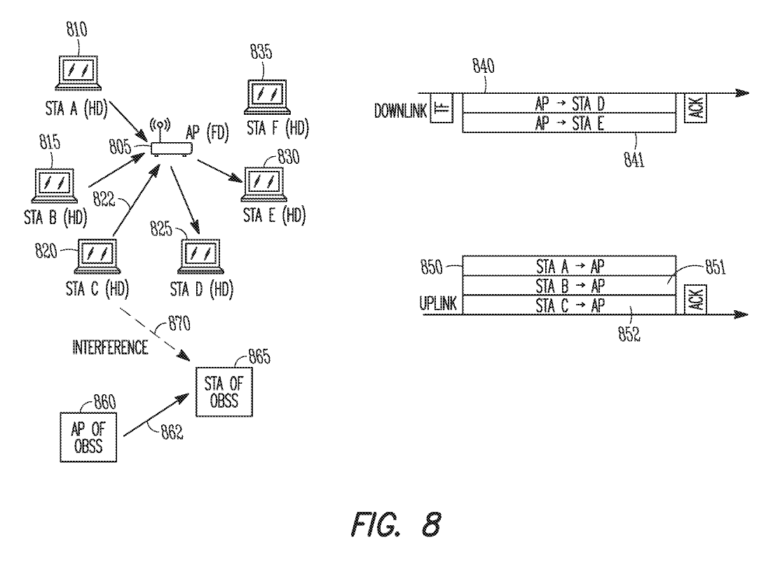

FIG. 8 illustrates another example scenario in which full-duplex (FD) and/or half-duplex (HD) communication may be used in accordance with some embodiments. It should be noted that the example scenario shown in FIG. 8 may illustrate some or all of the concepts and techniques described herein in some cases, but embodiments are not limited by the example scenario shown in FIG. 8. For instance, embodiments are not limited by the name, number, type, size, ordering, arrangement and/or other aspects of the frames, signals, fields, data blocks, time resources, channel resources and other elements as shown in FIG. 8. Although some of the elements shown in the examples of FIG. 8 may be included in an 802.11 standard and/or other standard, embodiments are not limited to usage of such elements that are included in standards.

Referring to FIG. 8, in an FD communication, STAs A, B and C (810, 815, and 820) may transmit uplink frames to the AP 805 while the STA D (825) and STA E (830) may receive downlink frames from the AP 805. As a non-limiting example, the STAs A, B, and C may use transmit power levels of 15 dBm (or other suitable power level) on allocated OFDMA sub-channels (such as 2 MHz, 4 MHz, 8 MHz or other suitable bandwidth) as long as their transmissions do not cause negative impact on downlink (DL) throughput performance (such as causing the AP 805 to use a lower MCS level and/or other impact).

In addition, an AP in overlapping basic service set (OBSS) 860 may transmit a downlink signal (as indicated by 862) to the STA 865 (which may be associated with the OBSS AP 860) in channel resources that are the same as (or significantly overlap) channel resources used by the AP 805 and the STAs 810-835. In some cases, uplink transmissions to the AP 805 may interfere with the downlink transmission 862 from the OBSS AP 860 to the STA 865. For instance, the uplink transmission 822 from STA C (825) to the AP 805 may produce unwanted interference 870 at the STA 865 that may impact the ability of the STA 865 to receive the downlink transmission 862. It should be pointed out that the interference 870 may be especially harmful in this scenario in FIG. 8 due to the significant overlapping of channel resources used for transmissions 862 and 822.

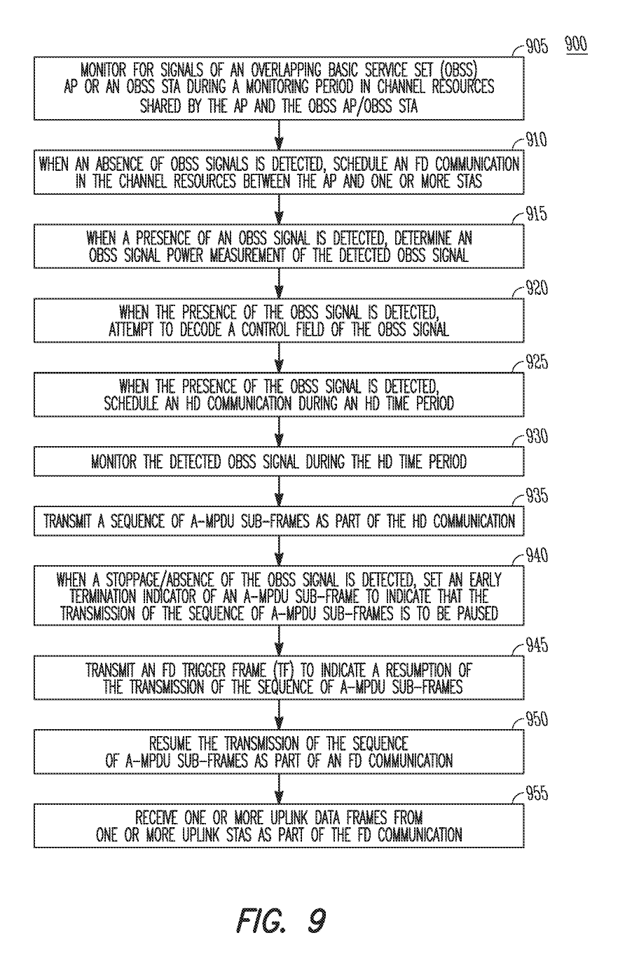

FIG. 9 illustrates the operation of another method of communication in accordance with some embodiments. It should be noted that embodiments of the method 900 may include additional or even fewer operations or processes in comparison to what is illustrated in FIG. 9 and embodiments of the method 900 are not necessarily limited to the chronological order that is shown in FIG. 9. In describing the method 900, reference may be made to FIGS. 1-8 and 10-15, although it is understood that the method 900 may be practiced with any other suitable systems, interfaces and components. In addition, embodiments of the method 900 may be applicable to APs 102, STAs 103, UEs, eNBs or other wireless or mobile devices. The method 900 may also be applicable to an apparatus for an AP 102, STA 103 and/or other device described above.

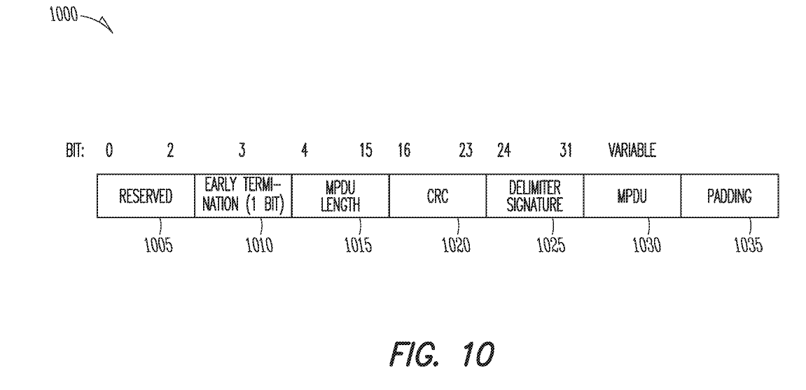

In addition, previous discussion of various techniques and concepts may be applicable to the method 700 in some cases, including full-duplex (FD), half-duplex (HD), FD request frames, FD response frames, interference frames (IFs), FD trigger frames (TFs), inter-STA interference measurements, candidate uplink group of STAs, candidate downlink group of STAs, downlink group of STAs, uplink group of STAs, master group of STAs and/or others. In addition, the examples shown in FIGS. 10-14B may also be applicable, in some cases, although the scope of embodiments is not limited in this respect.

In addition, references may be made to the AP 805 and/or OBSS AP 860 shown in FIG. 8 in descriptions herein (such as descriptions of the methods 900 and/or 1500), but it is understood that any AP (such as others described herein and/or others shown in any of the FIGs.) and/or any base station may be used. References may also be made to an STA (such as 810-835) and/or OBSS STA 865 shown in FIG. 8 in descriptions herein (such as descriptions of the methods 900 and/or 1500), but it is understood that any STA (such as others described herein and/or others shown in any of the FIGs.) and/or any mobile device may be used. In addition, embodiments are not limited by such references to the AP 805, STAs (810-835), AP 860 and/or STA 865 of the example scenario shown in FIG. 8.

It should also be noted that in some embodiments, a method practiced by an AP 102 and/or 805 may include one or more operations described for the method 900 and may include one or more operations described for the method 500. Some of those embodiments may include additional operations, including but not limited to operations described herein

At operation 905, the AP 805 may monitor for signals of an OBSS AP 860 and/or OBSS STA 865 during a monitoring period in channel resources, which may be shared, in some cases, by one or more of the AP 805, the OBSS AP 860, the OBSS STA 865, and other STAs (such as 810-835). In some embodiments, the AP 805 may monitor for a presence and/or absence of one or more OBSS transmissions during the monitoring period. Accordingly, the AP 805 may attempt to determine whether to schedule FD communication and/or HD communication based on whether there are any signal transmissions from the OBSS AP 860 and/or OBSS STA 865. The presence and/or absence may be determined, in some cases, based on a detected power level during the monitoring period. For instance, the presence/absence of one or more OBSS signals may be determined when the detected power level is above/below the threshold.

At operation 910, when an absence of OBSS signals is detected, the AP 805 may schedule an FD communication in the channel resources between the AP 805 and one or more STAs (such as 810-835). In some embodiments, time resources that substantially overlap may be used by the AP 805 for downlink transmission and uplink reception as part of the FD communication.

When a presence of one or more OBSS signals is detected, the AP 805 may perform one or more of operation 915, 920, 925 and 930. At operation 915, the AP 805 may determine an OBSS signal power measurement of the detected OBSS signal. At operation 920, the AP 805 may attempt to decode a control field of the OBSS to determine a duration of the OBSS signal. As a non-limiting example, a legacy signal (L-SIG) field may be decoded. At operation 925, the AP 805 may schedule an HD communication in the channel resources between the AP 805 and one or more downlink STAs (such as 810-835) during an HD time period. It should be noted that scheduling of HD communication is not limited to cases in which the presence of the OBSS signal(s) is detected. At operation 930, the AP 805 may monitor the detected OBSS signal (and/or monitor for an absence/presence of OBSS signals) during the HD time period.

In some embodiments, monitoring for the absence/presence of OBSS signals during transmission of downlink signals by the AP 805 may be performed in accordance with self-interference cancellation (SIC) techniques. The SIC techniques may reduce self-interference at the AP 805 caused by the downlink communication by the AP 805 while the AP 805 attempts to monitor/detect OBSS signals, such as OBSS signals transmitted by the OBSS AP 860 and/or OBSS STA 865. The AP 805 may monitor the detected OBSS signal(s) during the HD time period to determine whether to switch the HD communication to an FD communication during a remaining portion of the HD time period. It should be noted that the AP 805 may monitor the channel resources during the HD time period to determine if an absence of OBSS signals occurs.

It should be noted that the AP 805 may determine whether to schedule an FD communication or an HD communication based at least partly on operations such as 905, 915, 920 and/or others. In some embodiments, the AP 805 may schedule the HD downlink communication between the AP 805 and the downlink STA(s) 103 when the OBSS signal power measurement is above a predetermined OBSS clear channel assessment (CCA) threshold. The AP 805 may schedule the FD communication between the AP 805 and the one or more STAs (such as 810-835) when the OBSS signal power measurement is below the OBSS CCA threshold.

In some embodiments, when the control field (L-SIG and/or other) is decoded and when the control field indicates that the OBSS signal (and/or the OBSS signal transmission) is to end during the HD time period, the AP 805 may determine whether to switch the HD communication to the FD communication during the HD time period based at least partly on a difference between an end time of the HD time period and an end time of the OBSS signal. For instance, if the OBSS signal is to end before the HD time period ends, the AP 805 may decide to perform FD communication in a remainder of the time. In some cases, the AP 805 may decide to perform the FD communication when there is an acceptable amount of remainder time in the HD time period after the OBSS signal is to end (such as at least a certain time duration remaining).

In some embodiments, when the control field is not decoded, the AP 805 may monitor the detected OBSS signal during the HD time period to determine whether to switch the HD communication to the FD communication. That is, if the AP 805 is unable to determine when the OBSS signal is to end (such as not being able to decode the L-SIG or other control field), the AP 805 may monitor for an absence of OBSS signals to determine when the OBSS signal has ended.

At operation 935, the AP 805 may transmit, during the HD time period as part of the HD downlink communication, one or more aggregated medium access control protocol data units (A-MPDU) sub-frames. In some embodiments, each A-MPDU sub-frame may include an A-MPDU header, although the scope of embodiments is not limited in this respect. In addition, embodiments are not limited to transmission of A-MPDU sub-frames, as the AP 805 may transmit one or more A-MPDUs, in some embodiments.

As a non-limiting example, for a particular STA (such as 810), the AP 805 may transmit a sequence of A-MPDU sub-frames to the particular STA 810. It is understood that the usage of the STA 810 in this example is not limiting, as any of the STAs 810-835 shown in FIG. 8 may be used. At operation 940, when a stoppage of the OBSS signal is detected (and/or an absence of OBSS signals is detected after a previous detection of a presence of OBSS signal(s)), the AP 805 may decide to switch from the HD communication to the FD communication. It should be noted that in some embodiments, the AP 805 may use information of a decoded control field (such as the L-SIG and/or other) of an OBSS signal to determine whether to switch from the HD communication to the FD communication. The AP 805 may also determine when the switch is to be performed, based on the information of the decoded control field.

To enable the switch to the FD communication, the AP 805 may perform one or more operations to pause the transmission of the sequence of A-MPDU sub-frames to the STA 810. In some embodiments, the AP 805 may set an early termination indicator of one of the A-MPDU sub-frames to indicate that the transmission is to be paused. For instance, the AP 805 may set the early termination indicator of a next chronological A-MPDU sub-frame of the sequence to indicate that the transmission of the sequence of A-MPDU sub-frames is to be paused after the transmission of the next chronological A-MPDU sub-frame. This operation may be performed when the stoppage/absence is detected while a current A-MPDU sub-frame is being transmitted, and the AP 805 may indicate the pause in the next A-MPDU sub-frame. It should be noted that, in some embodiments, the AP 805 may indicate the pause using other fields of the A-MPDU sub-frame and/or other techniques.

At operation 945, the AP 805 may transmit an FD trigger frame (TF) that indicates a resumption of the transmission of the sequence of A-MPDU sub-frames in accordance with the FD communication. For instance, the FD-TF may indicate that the transmission of the sequence of A-MPDU sub-frames to STA 810 is to be resumed. In addition, the FD-TF may indicate one or more uplink STAs (such as one or more of 810-835) that are to transmit uplink signals as part of the FD communication during the remaining portion of the HD time period, in some embodiments.

At operation 950, the AP 805 may resume the transmission of the sequence of A-MPDU sub-frames to the STA 810 as part of an FD communication. In addition, at operation 955, the AP 805 may also receive one or more uplink data frames from the one or more uplink STAs (such as one or more of 810-835) as part of the FD communication during the remaining portion of the HD time period.

In addition, although this example describes pause and resumption operations for a transmission of A-MPDU sub-frames to the STA 810, it is understood that such pause and/or resumption operations may be performed for multiple STAs (such as two or more of 810-835), in some cases. As a non-limiting example, the AP 805 may set an early termination indicator in an A-MPDU sub-frame sent to a first STA 810 to indicate a pause in a transmission of a first sequence of A-MPDU sub-frames to the first STA 810. The AP 805 may also set an early termination indicator in an A-MPDU sub-frame sent to a second STA 815 to indicate a pause in a transmission of a second sequence of A-MPDU sub-frames to the second STA 815. The AP 805 may resume the transmissions of the first and second sequences after transmission of the FD-TF. This example may be extended to multiple STAs.

FIG. 10 illustrates an example aggregated medium access control protocol data unit (A-MPDU) sub-frame in accordance with some embodiments. It should be noted that the example A-MPDU sub-frame 1000 shown in FIG. 10 may illustrate some or all of the concepts and techniques described herein in some cases, but embodiments are not limited by the example A-MPDU sub-frame 1000. For instance, embodiments are not limited by the name, number, type, size, ordering, arrangement and/or other aspects of the fields, blocks, and other elements as shown in FIG. 10. In some embodiments, an A-MPDU sub-frame may include one or more of the fields shown in FIG. 10. In some embodiments, an A-MPDU sub-frame may include one or more additional fields. In some embodiments, an A-MPDU sub-frame may not necessarily include all fields shown in FIG. 10. Although the example A-MPDU sub-frame 1000 and/or some of the fields included in it may be included in an 802.11 standard and/or other standard, embodiments are not limited to usage of such elements that are included in standards.

The A-MPDU sub-frame 1000 may include an early termination indicator 1010 that may indicate whether a pause in a transmission of a sequence of A-MPDU sub-frames 1000 is to be paused by the AP 805. One or more other fields, such as an MPDU length 1015, a CRC 1020, a delimiter signature 1025, padding 1035 and/or others may be included, in some cases. One or more MPDUs 1030 may be included in some cases. The early termination indicator 1010 and the reserved bits 1005 may be part of an MPDU delimiter, in some embodiments.

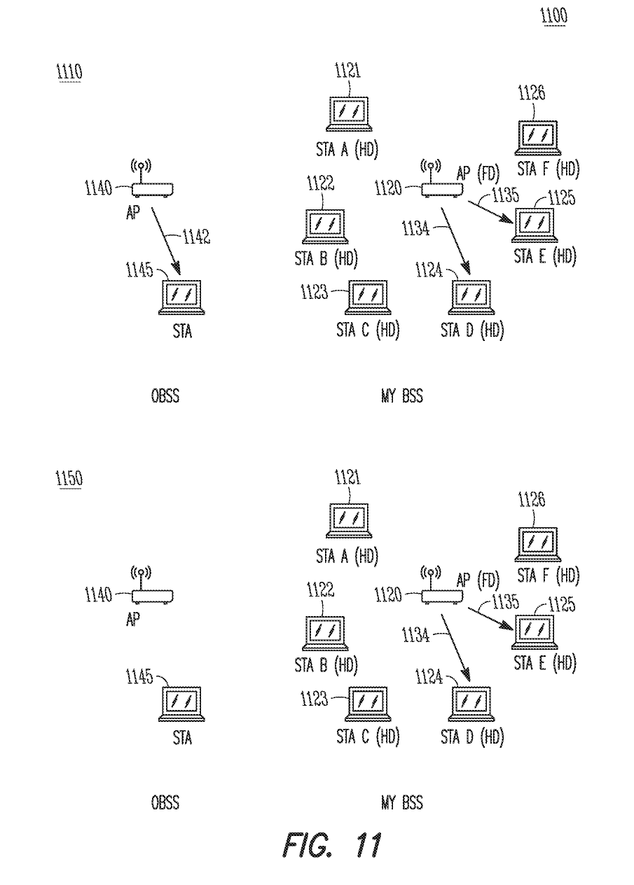

FIGS. 11-14B illustrate additional example scenarios in which FD and/or HD communication may be used in accordance with some embodiments. It should be noted that the example scenarios shown in FIGS. 11-14B may illustrate some or all of the concepts and techniques described herein (including but not limited to those of methods 900 and 1500), but embodiments are not limited by the example scenarios of FIGS. 11-14B. For instance, embodiments are not limited by the name, number, type, size, ordering, arrangement and/or other aspects of the APs 102, STAs 103, frames, signals, fields, data blocks, time resources, channel resources and other elements as shown in FIGS. 11-14B. Although some of the elements shown in the examples of FIGS. 11-14B may be included in an 802.11 standard and/or other standard, embodiments are not limited to usage of such elements that are included in standards.

It should be noted that the usage of “My BSS” in FIGS. 11-14B may refer to a domain that includes an AP (such as 805) that may perform one or more operations of the method 900, such as communication with one or more STAs (such as 810-835), which may also be included in the My BSS domain. The usage of “OBSS” in FIGS. 11-14B may refer to an OBSS domain that includes one or more OBSS APs (such as 860) and/or one or more OBSS STAs (such as 865). It is understood that the usage of these terminologies may serve to clarify the examples of FIGS. 11-14B, but such usage is not limiting. For instance, the My BSS domain and/or OBSS domain may not necessarily be included in some embodiments.

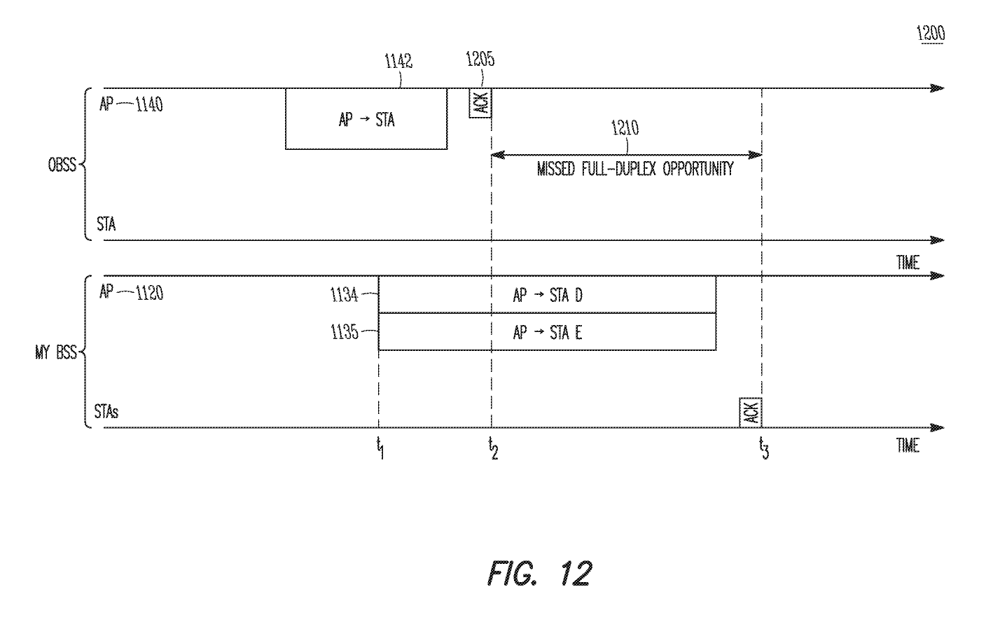

In some embodiments, full-duplex OFDMA communication may face challenges regarding spatial reuse in the presence of OBSS signals, especially in dense deployment scenarios. This is because simultaneous UL and DL OFDMA transmissions can cause a higher level of interference to OBSS transmissions. For instance, up to 9 STAs on 2 MHz sub-channels may transmit frames, each at a transmission power level of 15 dBm (or other suitable value). As an example, FIGS. 11 and 12 illustrate an example scenario in which an FD capability of the AP 1120 may not be fully utilized due to the presence of OBSS communication 1142 from the OBSS AP 1140. The AP 1120 may detect the OBSS communication 1142, and may schedule downlink communication (such as MU DL OFDMA transmission or other) in a half-duplex manner, such as 1134 with STA D 1124 and 1135 with STA E 1125. The HD communication may be scheduled (as opposed to FD communication) in order to avoid causing interference to OBSS communications such as 1142 between the OBSS AP 1140 and the OBSS STA 1145. In some cases, the AP 1120 may continue to use half-duplex communication even after the end of the OBSS communication 1142, as scheduling of uplink transmissions in the middle of downlink transmissions may be challenging. Referring to FIG. 12, the OBSS communication 1142 and the ACK 1205 may be finished by time t2. After time t2, the HD communications 1134 and 1135 between the AP 1120 and STAs 1124, 1125 may continue until time t3, in this example. In some cases, the AP 1120 may refrain from usage of FD during the time period between t2 and t3, which may be considered a missed FD opportunity as indicated by 1210.

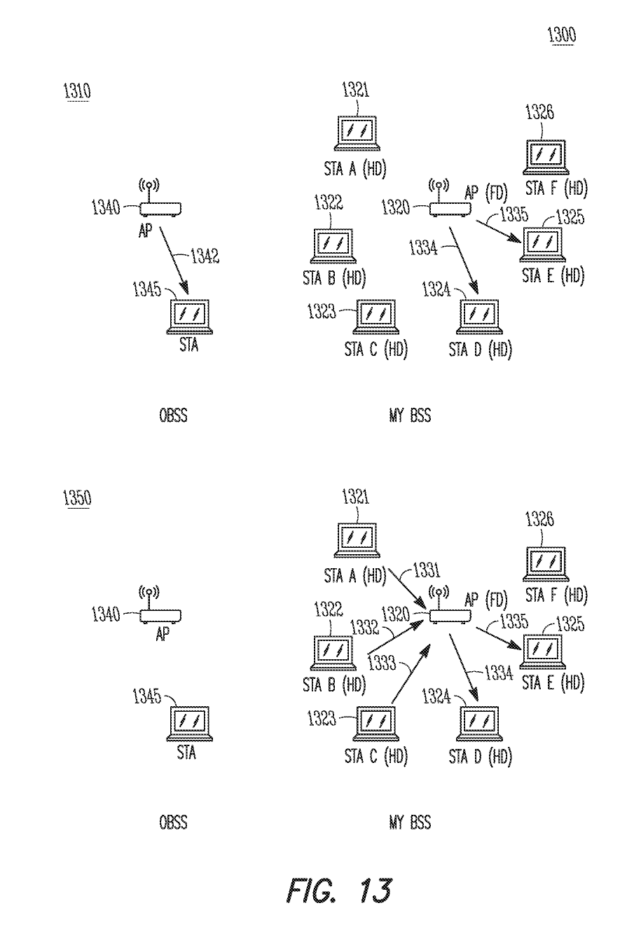

In some embodiments, the AP 102 may enable uplink transmissions (such as MU UL OFDMA transmissions) as part of an FD communication during on-going downlink transmissions (such as MU DL OFDMA transmissions). The AP 102 may monitor the OBSS signals while the AP 102 transmits downlink signals in accordance with an HD communication, and may determine if and/or when the OBSS signal transmission is to end or has ended. As an example, in FIG. 13, the AP 1320 may perform downlink transmissions 1334 and 1335 to STA D 1324 and STA E 1325 as part of an HD communication, and may refrain from scheduling uplink transmissions from any of STAs 1321-1323 and 1326 in order to avoid interfering with the OBSS transmission 1342 from the OBSS AP 1340 to the OBSS STA 1345. The AP 1320 may have detected the OBSS transmission 1342 previously, and may have scheduled the HD communication accordingly.

The AP 1320 may determine and/or detect that the OBSS transmission 1342 has ended or will end. As an example, the AP 1320 may use a network allocation vector (NAV) of the OBSS AP 1340 and/or OBSS transmission 1342 to determine the information about the end of the OBSS transmission 1342, as indicated by 1415. As another example, the AP 1320 may decode a control message such as a legacy signal (L-SIG) field and/or other to determine the information about the end of the OBSS transmission 1342. In these examples, the AP 1320 may transmit the FD-TF 1410 (or other TF or other type of frame, in some cases) to indicate uplink transmissions, such as 1331, 1332, 1333 by STAs A/B/C (1321, 1322, 1323) shown in 1350. Those uplink transmissions may start after a suitable time value, such as after t2 and/or after t3 in this case, as shown in 1400.

As another example, the AP 1320 may monitor the OBSS signal during the HD communication, as indicated by 1465, to determine the information about the end of the OBSS transmission 1342. The AP 1320 may transmit an FD-TF 1460 (or other TF or other type of frame, in some cases) to indicate uplink transmissions, such as 1331, 1332, 1333 by STAs A/B/C (1321, 1322, 1323). In the case of 1450, the FD-TF 1460 may be transmitted after the detection of the end of the OBSS transmission 1342. Those uplink transmissions may start after a suitable time value, such as after t2 and/or after t3 and/or after t4 in this case, as shown in 1450.

The AP 1320 may also use techniques described herein for pausing ongoing transmission of one or more sequences of downlink A-MPDU sub-frames (as in 1334, 1335) to transmit the FD-TF 1460. The pause may be indicated using any suitable technique, such as the early termination indicator, other field(s) of an A-MPDU sub-frame, other field(s) of an A-MPDU header and/or other techniques. The downlink transmissions 1334, 1335 may be resumed after the FD-TF 1460. In addition, uplink transmissions 1331, 1332, 1333 by STAs A/B/C (1321, 1322, 1323) may begin after the FD-TF 1460. Those uplink transmissions may be performed in accordance with control information included in the FD-TF 1460, in some cases.

In some embodiments, when a full-duplex AP 102 has data to transmit to STA(s) 103 and is to receive data from STA(s) 103, the AP 102 may perform one or more of the following operations (and/or other operations). The AP 102 may check for the presence or absence of any OBSS signals. If no OBSS signals are detected (absence), then the AP 102 may schedule FD OFDMA transmissions and may send an FD-TF to scheduled UL STAs 103 and/or DL STAs 103.

In some embodiments, if there is an OBSS signal detected (presence), then the AP 102 may check whether the OBSS signal is above a certain threshold, which may be predetermined in some cases. For instance, an OBSS clear channel assessment (CCA) threshold, such as −72 dBm or other suitable value, may be used. If the OBSS signal strength is above the OBSS CCA threshold, then the AP 102 may defer the transmissions until the end of OBSS communications. If the OBSS signal strength is below the OBSS CCA threshold, then the AP 102 decides whether it will schedule (i) only DL OFDM(A) transmissions or (ii) both DL and UL OFDMA transmissions.

In some embodiments, the AP 102 may schedule both DL and UL OFDM(A) transmissions depending on one or more factors, including but not limited to a number of UL STAs 103, location(s) of UL STA(s) 103 (if available), transmit power(s) of UL STA(s) 103, measured OBSS signal strength(s) and/or others. In this case (both DL and UL STAs 103 scheduled), the AP will allocate resources to both scheduled UL and DL STAs and send a full-duplex Trigger Frame to trigger simultaneous UL and DL OFDM(A) transmissions. The AP 102 may first schedule only DL OFDM(A) transmissions if it concludes that UL transmissions may cause significant interference to the on-going OBSS communications. In some embodiments, the AP 102 may determine information on the duration of the on-going OBSS communications. For instance, one or more fields of a control message (such as RATE and LENGTH fields of an L-SIG field) may be used to determine such information. The AP 102 may schedule both UL and DL transmissions and may send an FD-TF that includes the UL resource allocation information before starting transmission of DL OFDM(A) frames. In this case, the FD-TF may include the starting time of the UL OFDM(A) transmissions, which is scheduled after the end of on-going OBSS transmissions.

In some embodiments, upon the reception of DL OFDM(A) A-MPDU sub-frames, the scheduled DL STAs (for instance, STA D 1324 and STA E 1325 in FIG. 13) may perform one or more of the following operations and/or others. The STA 103 may de-aggregate MPDUs based on MPDU delimiter information (for instance, MPDU length, CRC, delimiter signature and/or others). For each A-MPDU sub-frame, the STA 103 may check the early termination (or pause) indication bit in the MPDU delimiter. For instance, a value of “1” may indicate a pause of MPDU transmission and a value of “0 may indicate no pause (normal). If the bit is set to “0” (normal), then the STA 103 may proceed to process the A-MPDU sub-frame. If the bit is set to “1” (pause), then the STA 103 may switch to the Rx mode; may wait for the FD-TF; and upon the reception of the FD-TF, may continue to receive the remaining A-MPDU sub-frames. At the end of the A-MPDU sub-frame reception, the STA 103 may prepare and send a block ACK to the AP 102.

It should be noted that while some embodiments may be applicable to dense deployment scenarios in which an OBSS signal may be present, some embodiments may be applicable to other use case scenarios. Moreover, full-duplex devices may consider one or more factors when making a decision to consider switching from HD communication to FD communication. Such factors may include an interference condition (such as a condition of the OBSS signal; SIC capability; an amount, presence and/or duration of data that is to be transmitted and/or received; changes in received signal strength, modulation coding scheme (MCS) and/or other factors; expected throughputs of HD and/or FD, including comparisons between those expected throughputs.

In some embodiments, the AP 102 may set a ‘CS’ bit to a particular value (such as “1” or other) for solicited UL STAs 103, so that the UL STAs 103 may perform channel sensing before the scheduled UL transmissions and may confirm the absence of OBSS signals.

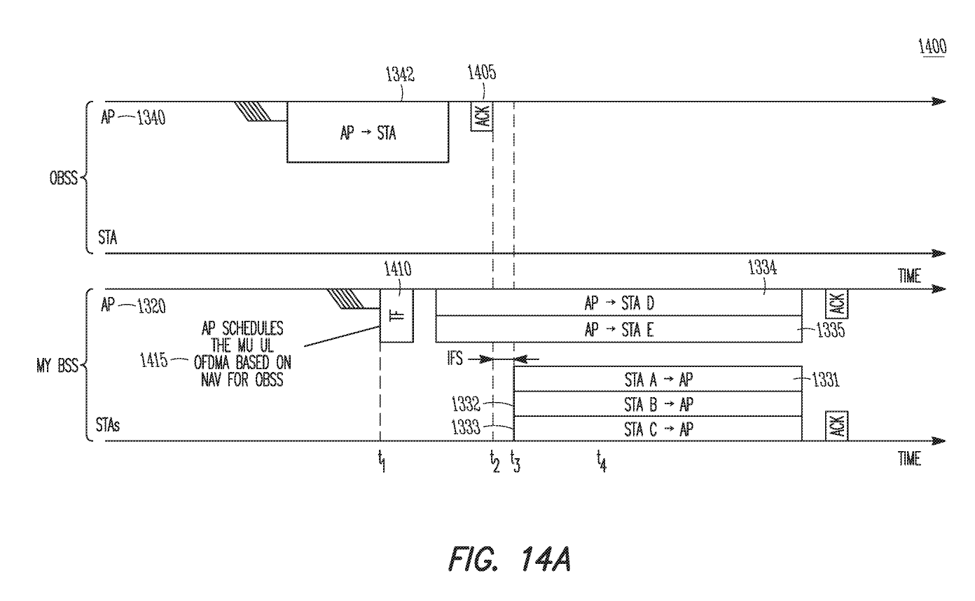

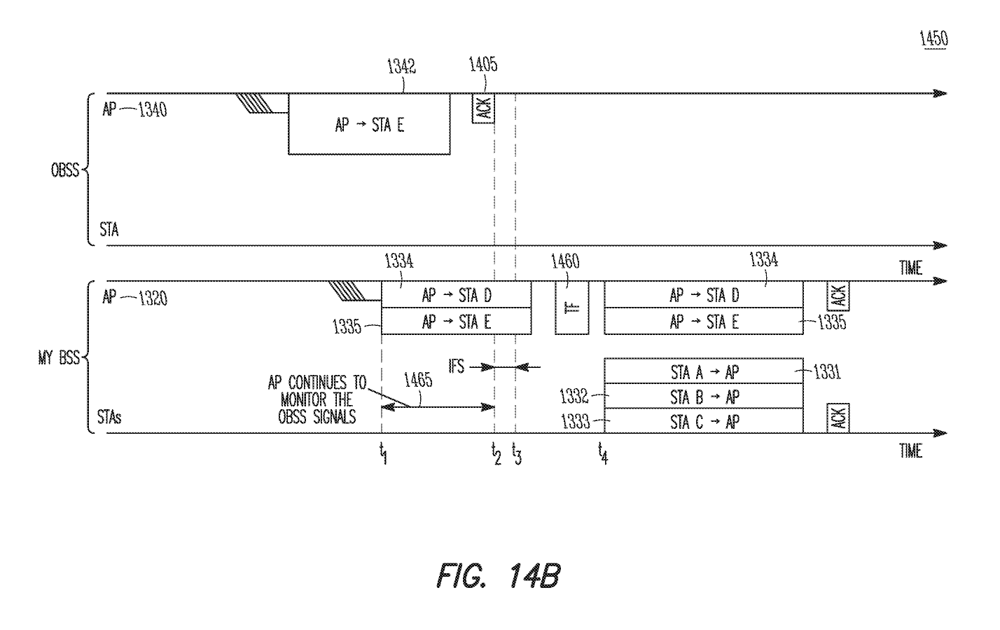

If the AP 102 does not have a-priori knowledge of the duration of the on-going OBSS communications, then the AP may start DL OFDM(A) transmissions without sending full-duplex Trigger Frame, as shown in 1450 of FIG. 14B. In this case, the AP may continue to monitor the OBSS signal strength using SIC capability, as indicated by 1465 in FIG. 14B. Upon the detection of the absence of the OBSS signal, and after an IFS time, the AP 102 may early terminate on-going DL OFDM(A) A-MPDU sub-frame transmissions (such as 1334, 1335 in 1450), and may send an FD-TF 1460 for both UL transmissions (such as 1331, 1332, 1333 in 1450) and DL OFDM(A) transmissions (such as 1334, 1335 in 1450), in some cases. In some embodiments, the AP 102 may set a ‘CS’ bit to 1 for solicited UL STAs 103, so that the UL STAs 103 may perform channel sensing before the scheduled UL transmissions.

In some embodiments, the AP 102 may indicate the early termination (or pause) of the on-going DL OFDM(A) transmissions by setting an early termination indication bit to ‘1’, which can be defined using one of the Reserved bits 1005 in an MPDU delimiter, as shown in FIG. 10.

In some embodiments, even upon the detection of the end of OBSS communications, the AP 102 may continue the on-going DL transmission when appropriate. For instance, whether to continue may be based on one or more factors such as a remaining DL transmission time, an expected UL transmission time, expected throughput performance and/or others. For example, the AP 102 may compare expected throughputs between HD and FD transmissions and may choose the one that maximizes the expected throughput performance. It should be noted that when the AP 102 opportunistically schedules UL OFDM(A) transmissions, the AP 102 may ensure that all the UL frame transmissions (including padded bits) end at the same time, in some cases. The AP 102 may also ensure that the UL transmissions end at the same time with the on-going DL transmissions, in some cases.

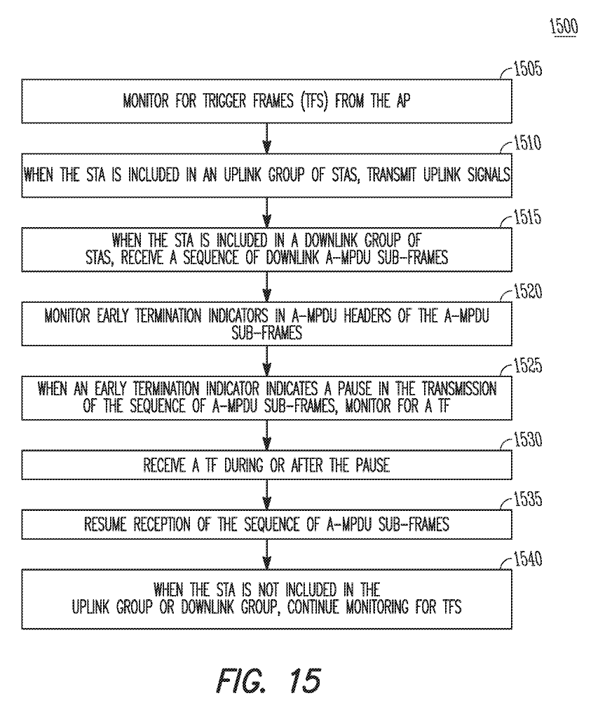

FIG. 15 illustrates the operation of another method of communication in accordance with some embodiments. As mentioned previously regarding the method 900, embodiments of the method 1500 may include additional or even fewer operations or processes in comparison to what is illustrated in FIG. 15 and embodiments of the method 1500 are not necessarily limited to the chronological order that is shown in FIG. 15. In describing the method 1500, reference may be made to FIGS. 1-14B, although it is understood that the method 1500 may be practiced with any other suitable systems, interfaces and components. In addition, embodiments of the method 1500 may be applicable to APs 102, STAs 103, UEs, eNBs or other wireless or mobile devices. The method 1500 may also be applicable to an apparatus for an AP 102, STA 103 and/or other device described above.

It should be noted that the method 1500 may be practiced by an STA 103 and may include exchanging of elements, such as frames, signals, messages, fields and/or other elements, with an AP 102. Similarly, the method 900 may be practiced at an AP 102 and may include exchanging of such elements with an STA 103. In some cases, operations and techniques described as part of the method 900 may be relevant to the method 1500. In addition, embodiments of the method 1500 may include operations performed at the STA 103 that are reciprocal to or similar to other operations described herein performed at the AP 102. For instance, an operation of the method 1500 may include reception of a frame from the AP 102 by the STA 103 while an operation of the method 900 may include transmission of the same frame or similar frame by the AP 102.

In addition, previous discussion of various techniques and concepts may be applicable to the method 1500 in some cases, including full-duplex (FD), half-duplex (HD), FD request frames, FD response frames, interference frames (IFs), FD trigger frames (TFs), inter-STA interference measurements, candidate uplink group of STAs, candidate downlink group of STAs, master group of STAs, OBSS signals, detection of OBSS signals, decoding of headers/fields of OBSS signals and/or others. In addition, the examples shown in FIGS. 10-14B may also be applicable, in some cases, although the scope of embodiments is not limited in this respect.

It should also be noted that in some embodiments, a method practiced by an STA 103 may include one or more operations described for the method 1500 and may include one or more operations described for the method 700. Some of those embodiments may include additional operations, including but not limited to operations described herein.

At operation 1505, the STA 103 may monitor for TFs from the AP 102. At operation 1510, when the STA is included in an uplink group of STAs 103, the STA 103 may transmit uplink signals to the AP 102. It should be noted that the uplink signals may be transmitted as part of an FD communication, in some cases, although the scope of embodiments is not limited in this respect.

At operation 1515, when the STA 103 is included in a downlink group of STAs 103, the STA 103 may receive a sequence of downlink A-MPDU sub-frames from the AP 102. It should be noted that the downlink A-MPDU sub-frames may be received as part of an FD communication or an HD communication. At operation 1520, the STA 103 may monitor one or more early termination indicators of the A-MPDU sub-frames. For instance, while receiving the sequence of downlink A-MPDU sub-frames from the AP 102, the STA 103 may determine whether the AP 102 intends to indicate, to the STA 103, a pause of the transmission of the sequence. The monitoring may be performed as part of either an HD communication or an FD communication. As a non-limiting example, the monitoring of the early termination indicators as part of an HD communication may enable the STA 103 to determine whether the HD communication is to be paused so that the AP 102 may send a TF to indicate uplink transmissions by other STAs 103 as part of an FD communication. In some embodiments, the early termination indicators may be included in A-MPDU headers of the A-MPDU sub-frames, although the scope of embodiments is not limited in this respect.

At operation 1525, when an early termination indicator indicates a pause in the transmission of the sequence of A-MPDU sub-frames, the STA 103 may monitor for a TF. In addition, the STA 103 may refrain from attempting to decode additional A-MPDU sub-frames in the sequence as part of the pause. The STA 103 may receive a TF during or after the pause at operation 1530. The STA 103 may resume the reception of the sequence of A-MPDU sub-frames at operation 1535.

At operation 1540, when the STA 103 is not included in the uplink group or downlink group, the STA 103 may continue monitoring for TFs. In some cases, the AP 102 may transmit a TF as part of the pause, and the STA 103 may receive the TF. When the STA 103 was not previously scheduled for either uplink or downlink communication, the TF may indicate that the STA 103 is to transmit uplink signals or receive downlink signals, in some cases.

In Example 1, an apparatus of an access point (AP) may comprise memory. The apparatus may further comprise processing circuitry. The processing circuitry may be configured to contend for access to channel resources during a transmission opportunity (TXOP). The processing circuitry may be further configured to select, from a master group of stations (STAs), a downlink group of the STAs and an uplink group of the STAs for a full-duplex (FD) communication during the TXOP in which the AP is to transmit downlink data to the downlink group and receive uplink data from the uplink group in overlapping time and channel resources. The processing circuitry may be further configured to encode, for transmission during the TXOP, a trigger frame (TF) that indicates the downlink group and further indicates an allocation of resource units (RUs) of the channel resources to the STAs of the uplink group for orthogonal frequency division multiple access (OFDMA) transmission of the uplink data. The selection of the downlink and uplink groups may be based at least partly on inter-STA interference indicators that are based on measurements of interference caused between STAs of the master group by uplink transmissions.

In Example 2, the subject matter of Example 1, wherein the processing circuitry may be further configured to, for at least one of the STAs of the master group, refrain from selection of the STA for the uplink group based at least partly on an expected interference that would be caused by the STA to one or more of the STAs of the downlink group. The expected interference may be based at least partly on the interference indicators.

In Example 3, the subject matter of one or any combination of Examples 1-2, wherein the processing circuitry may be further configured to, for at least one of the STAs of the master group, refrain from selection of the STA for the downlink group based at least partly on an expected interference that would be caused to the STA by one or more of the STAs of the uplink group. The expected interference may be based at least partly on the interference indicators.

In Example 4, the subject matter of one or any combination of Examples 1-3, wherein the processing circuitry may be further configured to select, from the master group of STAs, a candidate uplink group of the STAs and a candidate downlink group of the STAs. The processing circuitry may be further configured to encode, for transmission, an FD request frame that indicates: an allocation of resource units (RUs) of the channel resources to be used for an uplink OFDMA transmission of an FD response frame by the STAs of the candidate uplink group; and a request to receive, from the STAs of the candidate downlink group, one or more interference frames (IFs) that include one or more inter-STA interference indicators based on interference caused to the STAs of the candidate downlink group by the transmission of the FD response frame by the STAs of the candidate uplink group.

In Example 5, the subject matter of one or any combination of Examples 1-4, wherein the processing circuitry may be further configured to decode the one or more IFs from the STAs of the candidate downlink group. The processing circuitry may be further configured to determine, based at least partly on the one or more inter-STA interference indicators included in the one or more IFs, whether to select one or more of the STAs of the candidate downlink group for the downlink group and whether to select one or more of the STAs of the candidate uplink group for the uplink group.

In Example 6, the subject matter of one or any combination of Examples 1-5, wherein the determination of whether to select the one or more of the STAs of the candidate downlink group for the downlink group and whether to select the one or more of the STAs of the candidate uplink group for the uplink group may be further based at least partly on other inter-STA interference indicators included in other IFs received prior to the transmission of the FD request frame.

In Example 7, the subject matter of one or any combination of Examples 1-6, wherein the processing circuitry may be further configured to exclude one or more STAs of the candidate uplink group from the uplink group based at least partly on the one or more inter-STA interference indicators included in the one or more IFs. The processing circuitry may be further configured to include, in the uplink group, at least one STA of the master group that is not included in the candidate uplink group.

In Example 8, the subject matter of one or any combination of Examples 1-7, wherein the processing circuitry may be further configured to exclude the one or more STAs of the candidate uplink group from the uplink group when expected inter-STA interference caused by the excluded one or more STAs is above a pre-determined threshold.

In Example 9, the subject matter of one or any combination of Examples 1-8, wherein the STAs of the candidate uplink group and the STAs of the candidate downlink group may be selected based at least partly on a scheduling fairness criterion for the STAs of the master group.

In Example 10, the subject matter of one or any combination of Examples 1-9, wherein the processing circuitry may be further configured to encode, for transmission, a beacon frame or a management frame that indicate a request to receive, from one or more STAs of the master group, one or more interference frames (IFs). At least a portion of the inter-STA interference measurements used for the selection of the downlink and uplink groups may be included in the IFs.

In Example 11, the subject matter of one or any combination of Examples 1-10, wherein the STAs of the downlink and uplink groups may be selected further based at least partly on one or more of: an expected time for a downlink transmission or an uplink transmission, a scheduling fairness criterion for the STAs of the master group, and a target latency of an application of the AP or STA.

In Example 12, the subject matter of one or any combination of Examples 1-11, wherein the processing circuitry may be further configured to encode one or more downlink data frames for transmission to the STAs of the downlink group as part of the FD communication. The to decode one or more uplink data frames received from the STAs of the uplink group as part of the FD communication, the uplink data frames received as part of an OFDMA signal.

In Example 13, the subject matter of one or any combination of Examples 1-12, wherein the processing circuitry may include a baseband processor to encode the TF and to select the downlink and uplink groups.

In Example 14, the subject matter of one or any combination of Examples 1-13, wherein the apparatus may further include a transceiver to transmit the TF.

In Example 15, a non-transitory computer-readable storage medium may store instructions for execution by one or more processors to perform operations for communication by an access point (AP). The operations may configure the one or more processors to monitor for signals of an overlapping basic service set (OBSS) during a monitoring period in channel resources shared by the AP and the OBSS. The operations may further configure the one or more processors to, when an absence of OBSS signals is detected, schedule a full-duplex (FD) communication in the channel resources between the AP and one or more stations (STAs). Time resources that overlap may be used by the AP for downlink transmission and uplink reception. The operations may further configure the one or more processors to, when a presence of an OBSS signal is detected: schedule a half-duplex (HD) downlink communication in the channel resources between the AP and a downlink group of one or more STAs during an HD time period; and monitor the detected OBSS signal during the HD time period to determine whether to switch from the HD communication to the FD communication during a remaining portion of the HD time period.

In Example 16, the subject matter of Example 15, wherein the operations may further configure the one or more processors to encode, for transmission to a first STA of the downlink group during the HD time period as part of the HD downlink communication, a sequence of aggregated medium access control protocol data unit (A-MPDU) sub-frames. The operations may further configure the one or more processors to, when a stoppage of the OBSS signal is detected, set an early termination indicator of a next chronological A-MPDU sub-frame of the sequence to indicate that the transmission of the sequence of A-MPDU sub-frames is to be paused after the transmission of the next chronological A-MPDU sub-frame. The operations may further configure the one or more processors to encode, for transmission, a trigger frame (TF) that indicates a resumption of the transmission of the sequence of A-MPDU sub-frames as part of the FD communication during the remaining portion of the HD time period.

In Example 17, the subject matter of one or any combination of Examples 15-16, wherein the TF may further indicate an uplink group of one or more STAs that are to transmit uplink signals as part of the FD communication during the remaining portion of the HD time period. The operations may further configure the one or more processors to decode one or more uplink data frames received from the uplink group as part of the FD communication during the remaining portion of the HD time period.

In Example 18, the subject matter of one or any combination of Examples 15-17, wherein the operations may further configure the one or more processors to monitor the detected OBSS signal during the HD time period in accordance with self-interference cancellation (SIC), the SIC to reduce self-interference at the AP caused by the downlink communication by the AP.

In Example 19, the subject matter of one or any combination of Examples 15-18, wherein the operations may further configure the one or more processors to, when the presence of the OBSS signal is detected, determine an OBSS signal power measurement of the detected OBSS signal. The operations may further configure the one or more processors to schedule the HD downlink communication when the OBSS signal power measurement is above a predetermined OBSS clear channel assessment (CCA) threshold. The operations may further configure the one or more processors to schedule the FD communication when the OBSS signal power measurement is below the OBSS CCA threshold.

In Example 20, the subject matter of one or any combination of Examples 15-19, wherein the operations may further configure the one or more processors to, when the presence of the OBSS signal is detected: attempt to decode a control field of the OBSS to determine a duration of the OBSS signal; when the control field is decoded and when the control field indicates that the OBSS signal is to end during the HD time period, determine whether to switch the HD communication to the FD communication during the HD time period based at least partly on a difference between an end time of the HD time period and an end time of the OBSS signal; and when the control field is not decoded, monitor the detected OBSS signal during the HD time period to determine whether to switch the HD communication to the FD communication.

In Example 21, a method of full-duplex (FD) communication at an access point (AP) may comprise selecting, for an FD communication in which the AP is to transmit one or more downlink data frames and is to receive one or more uplink data frames in time and channel resources that overlap, a candidate downlink group of one or more stations (STAs) and a candidate uplink group of one or more STAs. The method may further comprise encoding, for transmission, an FD request frame that allocates resource units (RUs) of the channel resources for orthogonal frequency division multiple access (OFDMA) transmission of an FD response frame by the STAs of the candidate uplink group. The method may further comprise decoding, from the candidate downlink group, one or more interference frames (IFs) that include one or more inter-STA interference measurements, at the STAs of the candidate downlink group, of the OFDMA transmission of the FD response frame by the STAs of the candidate uplink group. The method may further comprise determining, based at least partly on the inter-STA interference measurements included in the IF, whether to schedule each STA of the candidate uplink group for uplink transmission of the uplink data frames as part of the FD communication.

In Example 22, the subject matter of Example 21, wherein the method may further comprise refraining from scheduling at least a portion of the STAs of the candidate uplink group for the uplink transmission when the inter-STA interference measurements indicate that inter-STA interference caused to one or more of the STAs of the candidate downlink group by the STAs of the portion is above a pre-determined threshold.

In Example 23, the subject matter of one or any combination of Examples 21-22, wherein the method may further comprise contending for access to the channel resources for communication during a transmission opportunity (TXOP). The method may further comprise encoding, for transmission, a trigger frame (TF) that indicates an allocation of the RUs for OFDMA transmission of the uplink data frames. The FD communication may be performed during the TXOP, the FD request frame is transmitted during the TXOP, and the IF is received during the TXOP.

In Example 24, an apparatus of a station (STA) may comprise memory. The apparatus may further comprise processing circuitry. The processing circuitry may be configured to receive a full-duplex (FD) request frame from an access point (AP) that indicates a candidate downlink group of one or more STAs and a candidate uplink group of one or more STAs for an FD communication. The FD request frame may further indicate an allocation of resource units (RUs) to the STAs of the candidate uplink group for orthogonal frequency division multiple access (OFDMA) transmission of an FD response frame. The processing circuitry may be further configured to, when the STA is included in the candidate uplink group, encode a message for transmission in the FD response frame in the RU allocated to the STA in the FD request frame. The processing circuitry may be further configured to, when the STA is included in the candidate downlink group: determine inter-STA measurements of the STAs of the candidate uplink group based on received power measurements of the FD response frame at the STA and further based on the RU allocation indicated by the FD request frame; and encode the inter-STA measurements for transmission to the AP.

In Example 25, the subject matter of Example 24, wherein the processing circuitry may be further configured to determine the inter-STA measurements of each of the STAs of the candidate uplink group based on a measurement, at the STA, of a received power of the FD request frame in the RU allocated to each of the STAs of the candidate uplink group.

In Example 26, the subject matter of one or any combination of Examples 24-25, wherein the processing circuitry may be further configured to encode, for transmission to the AP, an interference frame (IF) that includes the inter-STA measurements.

In Example 27, the subject matter of one or any combination of Examples 24-26, wherein the processing circuitry may be further configured to, when the STA is not included in the candidate uplink group or the candidate downlink group: determine inter-STA measurements of the STAs of the candidate uplink group based on received power measurements of the FD response frame at the STA and further based on the RU allocation indicated by the FD request frame; and encode the inter-STA measurements for transmission to the AP.

In Example 28, the subject matter of one or any combination of Examples 24-27, wherein the processing circuitry may be further configured to decode a trigger frame (TF) that indicates a downlink group of STAs that are to receive downlink data from the AP during an FD period and an uplink group of STAs that are to transmit uplink data to the AP during the FD period. The processing circuitry may be further configured to, when the STA is included in the uplink group, encode one or more uplink data frames for uplink OFDMA transmission in an RU indicated in the FD-TF during the FD period. The processing circuitry may be further configured to, when the STA is included in the downlink group, decode one or more downlink data frames received during the FD period.

In Example 29, an apparatus of an access point (AP) may comprise means for monitoring for signals of an overlapping basic service set (OBSS) during a monitoring period in channel resources shared by the AP and the OBSS. The apparatus may further comprise means for scheduling, when an absence of OBSS signals is detected, a full-duplex (FD) communication in the channel resources between the AP and one or more stations (STAs). Time resources that overlap may be used by the AP for downlink transmission and uplink reception. The apparatus may further comprise means for, when a presence of an OBSS signal is detected: scheduling a half-duplex (HD) downlink communication in the channel resources between the AP and a downlink group of one or more STAs during an HD time period; and monitoring the detected OBSS signal during the HD time period to determine whether to switch from the HD communication to the FD communication during a remaining portion of the HD time period.

In Example 30, the subject matter of Example 29, wherein the apparatus may further comprise means for encoding, for transmission to a first STA of the downlink group during the HD time period as part of the HD downlink communication, a sequence of aggregated medium access control protocol data unit (A-MPDU) sub-frames. The apparatus may further comprise means for setting, when a stoppage of the OBSS signal is detected, an early termination indicator of a next chronological A-MPDU sub-frame of the sequence to indicate that the transmission of the sequence of A-MPDU sub-frames is to be paused after the transmission of the next chronological A-MPDU sub-frame. The apparatus may further comprise means for encoding, for transmission, a trigger frame (TF) that indicates a resumption of the transmission of the sequence of A-MPDU sub-frames as part of the FD communication during the remaining portion of the HD time period.

In Example 31, the subject matter of one or any combination of Examples 29-30, wherein the TF may further indicate an uplink group of one or more STAs that are to transmit uplink signals as part of the FD communication during the remaining portion of the HD time period. The apparatus may further comprise means for decoding one or more uplink data frames received from the uplink group as part of the FD communication during the remaining portion of the HD time period.

In Example 32, the subject matter of one or any combination of Examples 29-31, wherein the apparatus may further comprise means for monitoring the detected OBSS signal during the HD time period in accordance with self-interference cancellation (SIC), the SIC to reduce self-interference at the AP caused by the downlink communication by the AP.

In Example 33, the subject matter of one or any combination of Examples 29-32, wherein the apparatus may further comprise means for determining, when the presence of the OBSS signal is detected, an OBSS signal power measurement of the detected OBSS signal. The apparatus may further comprise means for scheduling the HD downlink communication when the OBSS signal power measurement is above a predetermined OBSS clear channel assessment (CCA) threshold. The apparatus may further comprise means for scheduling the FD communication when the OBSS signal power measurement is below the OBSS CCA threshold.

In Example 34, the subject matter of one or any combination of Examples 29-33, wherein the apparatus may further comprise means for, when the presence of the OBSS signal is detected: attempting to decode a control field of the OBSS to determine a duration of the OBSS signal; when the control field is decoded and when the control field indicates that the OBSS signal is to end during the HD time period, determining whether to switch the HD communication to the FD communication during the HD time period based at least partly on a difference between an end time of the HD time period and an end time of the OBSS signal; and when the control field is not decoded, monitoring the detected OBSS signal during the HD time period to determine whether to switch the HD communication to the FD communication.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus of an access point (AP), the apparatus comprising: memory; and processing circuitry, configured to:
contend for access to channel resources during a transmission opportunity (TXOP);
select, from a master group of stations (STAs), a downlink group of the STAs and an uplink group of the STAs for a full-duplex (FD) communication during the TXOP in which the AP is to transmit downlink data to the downlink group and receive uplink data from the uplink group in overlapping time and channel resources; and
encode, for transmission during the TXOP, a trigger frame (TF) that indicates the downlink group and further indicates an allocation of resource units (RUs) of the channel resources to the STAs of the uplink group for orthogonal frequency division multiple access (OFDMA) transmission of the uplink data,
wherein the selection of the downlink and uplink groups is based at least partly on inter-STA interference indicators that are based on measurements of interference caused between STAs of the master group by uplink transmissions.

2. The apparatus according to claim 1, the processing circuitry further configured to, for at least one of the STAs of the master group, refrain from selection of the STA for the uplink group based at least partly on an expected interference that would be caused by the STA to one or more of the STAs of the downlink group, wherein the expected interference is based at least partly on the interference indicators.

3. The apparatus according to claim 1, the processing circuitry further configured to, for at least one of the STAs of the master group, refrain from selection of the STA for the downlink group based at least partly on an expected interference that would be caused to the STA by one or more of the STAs of the uplink group, wherein the expected interference is based at least partly on the interference indicators.

4. The apparatus according to claim 1, the processing circuitry further configured to:
select, from the master group of STAs, a candidate uplink group of the STAs and a candidate downlink group of the STAs; and
encode, for transmission, an FD request frame that indicates:
an allocation of resource units (RUs) of the channel resources to be used for an uplink OFDMA transmission of an FD response frame by the STAs of the candidate uplink group, and
a request to receive, from the STAs of the candidate downlink group, one or more interference frames (IFs) that include one or more inter-STA interference indicators based on interference caused to the STAs of the candidate downlink group by the transmission of the FD response frame by the STAs of the candidate uplink group.

5. The apparatus according to claim 4, the processing circuitry further configured to:
decode the one or more IFs from the STAs of the candidate downlink group; and
determine, based at least partly on the one or more inter-STA interference indicators included in the one or more IFs, whether to select one or more of the STAs of the candidate downlink group for the downlink group and whether to select one or more of the STAs of the candidate uplink group for the uplink group.

6. The apparatus according to claim 5, wherein the determination of whether to select the one or more of the STAs of the candidate downlink group for the downlink group and whether to select the one or more of the STAs of the candidate uplink group for the uplink group is further based at least partly on other inter-STA interference indicators included in other IFs received prior to the transmission of the FD request frame.

7. The apparatus according to claim 4, the processing circuitry further configured to:
exclude one or more STAs of the candidate uplink group from the uplink group based at least partly on the one or more inter-STA interference indicators included in the one or more IFs; and
include, in the uplink group, at least one STA of the master group that is not included in the candidate uplink group.

8. The apparatus according to claim 7, the processing circuitry further configured to:
exclude the one or more STAs of the candidate uplink group from the uplink group when expected inter-STA interference caused by the excluded one or more STAs is above a pre-determined threshold.

9. The apparatus according to claim 4, wherein the STAs of the candidate uplink group and the STAs of the candidate downlink group are selected based at least partly on a scheduling fairness criterion for the STAs of the master group.

10. The apparatus according to claim 1, the processing circuitry further configured to:
encode, for transmission, a beacon frame or a management frame that indicate a request to receive, from one or more STAs of the master group, one or more interference frames (IFs),
wherein at least a portion of the inter-STA interference measurements used for the selection of the downlink and uplink groups is included in the IFs.

11. The apparatus according to claim 1, wherein the STAs of the downlink and uplink groups are selected further based at least partly on one or more of: an expected time for a downlink transmission or an uplink transmission, a scheduling fairness criterion for the STAs of the master group, and a target latency of an application of the AP or STA.

12. The apparatus according to claim 1, the processing circuitry further configured to:
encode one or more downlink data frames for transmission to the STAs of the downlink group as part of the FD communication; and
decode one or more uplink data frames received from the STAs of the uplink group as part of the FD communication, the uplink data frames received as part of an OFDMA signal.

13. The apparatus according to claim 1, wherein the processing circuitry includes a baseband processor to encode the TF and to select the downlink and uplink groups.

14. The apparatus according to claim 1, wherein the apparatus further includes a transceiver to transmit the TF.

15. A non-transitory computer-readable storage medium that stores instructions for execution by one or more processors to perform operations for communication by an access point (AP), the operations to configure the one or more processors to:
monitor for signals of an overlapping basic service set (OBSS) during a monitoring period in channel resources shared by the AP and the OBSS;
when an absence of OBSS signals is detected, schedule a full-duplex (FD) communication in the channel resources between the AP and one or more stations (STAs), wherein time resources that overlap are to be used by the AP for downlink transmission and uplink reception; and
when a presence of an OBSS signal is detected:
schedule a half-duplex (HD) downlink communication in the channel resources between the AP and a downlink group of one or more STAs during an HD time period; and
monitor the detected OBSS signal during the HD time period to determine whether to switch from the HD communication to the FD communication during a remaining portion of the HD time period.

16. The non-transitory computer-readable storage medium according to claim 15, the operations to further configure the one or more processors to:
encode, for transmission to a first STA of the downlink group during the HD time period as part of the HD downlink communication, a sequence of aggregated medium access control protocol data unit (A-MPDU) sub-frames; and
when a stoppage of the OBSS signal is detected, set an early termination indicator of a next chronological A-MPDU sub-frame of the sequence to indicate that the transmission of the sequence of A-MPDU sub-frames is to be paused after the transmission of the next chronological A-MPDU sub-frame; and
encode, for transmission, a trigger frame (TF) that indicates a resumption of the transmission of the sequence of A-MPDU sub-frames as part of the FD communication during the remaining portion of the HD time period.

17. The non-transitory computer-readable storage medium according to claim 16, wherein:
the TF further indicates an uplink group of one or more STAs that are to transmit uplink signals as part of the FD communication during the remaining portion of the HD time period, and
the operations are to further configure the one or more processors to decode one or more uplink data frames received from the uplink group as part of the FD communication during the remaining portion of the HD time period.

18. The non-transitory computer-readable storage medium according to claim 15, the operations to further configure the one or more processors to monitor the detected OBSS signal during the HD time period in accordance with self-interference cancellation (SIC), the SIC to reduce self-interference at the AP caused by the downlink communication by the AP.

19. The non-transitory computer-readable storage medium according to claim 15, the operations to further configure the one or more processors to:
when the presence of the OBSS signal is detected, determine an OBSS signal power measurement of the detected OBSS signal;
schedule the HD downlink communication when the OBSS signal power measurement is above a predetermined OBSS clear channel assessment (CCA) threshold; and
schedule the FD communication when the OBSS signal power measurement is below the OBSS CCA threshold.

20. The non-transitory computer-readable storage medium according to claim 15, the operations to further configure the one or more processors to:
when the presence of the OBSS signal is detected:
attempt to decode a control field of the OBSS to determine a duration of the OBSS signal;
when the control field is decoded and when the control field indicates that the OBSS signal is to end during the HD time period, determine whether to switch the HD communication to the FD communication during the HD time period based at least partly on a difference between an end time of the HD time period and an end time of the OBSS signal; and
when the control field is not decoded, monitor the detected OBSS signal during the HD time period to determine whether to switch the HD communication to the FD communication.

21. A method of full-duplex (FD) communication at an access point (AP), the method comprising:
selecting, for an FD communication in which the AP is to transmit one or more downlink data frames and is to receive one or more uplink data frames in time and channel resources that overlap, a candidate downlink group of one or more stations (STAs) and a candidate uplink group of one or more STAs;
encoding, for transmission, an FD request frame that allocates resource units (RUs) of the channel resources for orthogonal frequency division multiple access (OFDMA) transmission of an FD response frame by the STAs of the candidate uplink group;
decoding, from the candidate downlink group, one or more interference frames (IFs) that include one or more inter-STA interference measurements, at the STAs of the candidate downlink group, of the OFDMA transmission of the FD response frame by the STAs of the candidate uplink group; and
determining, based at least partly on the inter-STA interference measurements included in the IF, whether to schedule each STA of the candidate uplink group for uplink transmission of the uplink data frames as part of the FD communication.

22. The method according to claim 21, the method further comprising refraining from scheduling at least a portion of the STAs of the candidate uplink group for the uplink transmission when the inter-STA interference measurements indicate that inter-STA interference caused to one or more of the STAs of the candidate downlink group by the STAs of the portion is above a pre-determined threshold.

23. The method according to claim 21, the method further comprising:
contending for access to the channel resources for communication during a transmission opportunity (TXOP); and
encoding, for transmission, a trigger frame (TF) that indicates an allocation of the RUs for OFDMA transmission of the uplink data frames,
wherein the FD communication is to be performed during the TXOP, the FD request frame is transmitted during the TXOP, and the IF is received during the TXOP.

24. An apparatus of a station (STA), the apparatus comprising: memory; and processing circuitry, configured to:
receive a full-duplex (FD) request frame from an access point (AP) that indicates a candidate downlink group of one or more STAs and a candidate uplink group of one or more STAs for an FD communication, wherein the FD request frame further indicates an allocation of resource units (RUs) to the STAs of the candidate uplink group for orthogonal frequency division multiple access (OFDMA) transmission of an FD response frame;
when the STA is included in the candidate uplink group: encode a message for transmission in the FD response frame in the RU allocated to the STA in the FD request frame; and
when the STA is included in the candidate downlink group:
determine inter-STA measurements of the STAs of the candidate uplink group based on received power measurements of the FD response frame at the STA and further based on the RU allocation indicated by the FD request frame; and
encode the inter-STA measurements for transmission to the AP.

25. The apparatus according to claim 24, the processing circuitry further configured to determine the inter-STA measurements of each of the STAs of the candidate uplink group based on a measurement, at the STA, of a received power of the FD request frame in the RU allocated to each of the STAs of the candidate uplink group.

26. The apparatus according to claim 25, the processing circuitry further configured to encode, for transmission to the AP, an interference frame (IF) that includes the inter-STA measurements.

27. The apparatus according to claim 24, the processing circuitry further configured to:
when the STA is not included in the candidate uplink group or the candidate downlink group:
determine inter-STA measurements of the STAs of the candidate uplink group based on received power measurements of the FD response frame at the STA and further based on the RU allocation indicated by the FD request frame; and
encode the inter-STA measurements for transmission to the AP.

28. The apparatus according to claim 24, the processing circuitry further configured to:
decode a trigger frame (TF) that indicates a downlink group of STAs that are to receive downlink data from the AP during an FD period and an uplink group of STAs that are to transmit uplink data to the AP during the FD period;
when the STA is included in the uplink group, encode one or more uplink data frames for uplink OFDMA transmission in an RU indicated in the FD-TF during the FD period; and
when the STA is included in the downlink group, decode one or more downlink data frames received during the FD period.
